(19) United States
(12) Patent Application Publication
(10) Pub. No.: US 2009/0303009 A1
(43) Pub. Date: Dec. 10, 2009

(54) Information processing apparatus for transmitting and receiving RF signals

(75) Inventors: Akira Itasaki, Kawasaki (JP); Isamu Yamada, Kawasaki (JP); Shinichi Shiotsu, Kawasaki (JP); Satoshi Inano, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/382,296

(22) Filed: Mar. 12, 2009

(30) Foreign Application Priority Data
Jun. 6, 2008 (JP) 2008-149323

(51) Int. Cl. H04Q 5/22

(52) U.S. Cl. 340/10.1

(57) ABSTRACT

An information processing apparatus includes: a physical quantity detector unit which transforms a physical quantity into an electric signal and provides a detected value represented by the electric signal; a physical quantity determiner unit which determines whether the detected value is larger than a given threshold value; a timer unit which measures a time period during which it continues to be determined that the detected value is not larger than the given threshold value, in response to the determination that the detected value is not larger than the given threshold value after it is determined that the detected value is larger than the given threshold; a transmitter unit which transmits a request signal for requesting transmission of data, when the time period measured by the timer unit transcends a first given time threshold; and a receiver unit which receives transmitted data which is transmitted in response to the request signal.

### CROSS-REFERENCE TO RELATED APPLICATIONS

This application is based upon and claims the benefit of priority of the prior Japanese Patent Application No. 2008-149323, filed on Jun. 6, 2008, the entire content of which is incorporated herein by reference.

### BACKGROUND OF THE INVENTION

1. Field of the Invention

A certain aspect of the embodiments discussed herein is related generally to an information processing apparatus or device which transmits and receives RF signals, and in particular to a contactless information read/write device which transmits and receives RF signals in accordance with a physical quantity detected in the information reader/writer device.

2. Description of the Related Art

An RF ID tag with a battery power supply or of an active type, which may be attached to a merchandise article or the like, or carried by a person, transmits an RF signal at a given frequency that carries an ID and other information related to the article or the person, so that the RF signal is received and the information is read out by a reader device. The read-out information is further processed by a computer or the like, so that the distribution of the article or the action of the person is monitored and managed. The active-type RF ID tag with battery power supply has a larger communication range than a passive-type RF ID tag that receives power from a reader/writer device in a contactless manner, and hence is practical in use. There is an improved active-type RF ID tag that responds only to a tag ID request transmitted by the reader/writer device.

Japanese Laid-open Patent Application Publication No. JP 2006-338489 published on Dec. 14, 2006 (which corresponds to US Patent Application Publication No. US 2006/276206 (A1)) describes an information access system for accessing information stored in an active-type contactless information storage device. In this information access system, a reader/writer device continually transmits an ID request signal at a first frequency and is continuously ready to receive an RF signal at a second frequency. The active-type contactless information storage device has a memory, a control unit, a battery, a timer for measuring time, a receiver unit for sensing a carrier of an RF signal at the first frequency, and a transmitter unit for transmitting a response signal at the second frequency when the ID request signal is received. The control unit controls the receiver unit to sense a carrier of an RF signal at the first frequency in given periods occurring in a given cycle. When the receiver unit senses and detects a carrier of an RF signal at the first frequency in a particular given period, the control unit causes the receiver unit to receive further the ID request signal, and, in response to the ID request signal, causes the transmitter unit to transmit a response signal at the second frequency carrying an ID of the active-type contactless information storage device stored in the memory. In the carrier sensing, the control unit causes the receiver unit to be in an active state and the transmitter unit to be in an inactive state in the particular given period and a subsequent given period. When the receiver unit attempts to sense a carrier of the RF signal at the first frequency in the particular given period but detects no carrier, the control unit controls the receiver unit and the transmitter unit to maintain the inactive state during a non-carrier sensing period between the particular given period for carrier sensing and the subsequent given period for subsequent carrier sensing. Thus, the power consumption of the active-type contactless information storage device may be decreased.

A reader/writer device may read out information in an active-type RF ID tag, which has a sensor for detecting a physical quantity in its ambient environment and stores data of such detected quantity values, so that the reader/writer device collects the data of such detected values together with an ID of the RF ID tag.

International Publication Pamphlet No. WO 01/17804 (which corresponds to U.S. Pat. No. 6,828,905 (B2)) describes a system for monitoring and signaling by radio a pressure in pneumatic tires of wheels on vehicles. In this system, a pressure or a change in pressure in pneumatic tires of wheels on vehicles is monitored and signaled by radio. The system includes a receiver unit provided in or on the vehicle to which at least one antenna is associated, and a transmitter unit, arranged in the pneumatic tire, for measuring, evaluating and transmitting tire pressure signals. The transmitter unit does not transmit the pressure signal to the receiver unit as long as the change in pressure does not exceed a threshold value. Thereby, electricity may be saved.

Japanese Laid-open Patent Application Publication No. JP 2000-194803 published on Jul. 14, 2000 describes a non-contact IC card system using a reader/writer for a non-contact IC card. In this system, a proximity sensor for detecting an object is attached to the reader/writer. Unless the proximity sensor detects an object such as the non-contact IC card, the reader/writer does not transmit transmission data according to a command from a control part. Only when the proximity sensor detects the object such as the non-contact IC card, the reader/writer transmits transmission data according to a command from the control part, via an I/O converter, an oscillation part, a modulation part, a power amplification part, and a transmitting and receiving coil, for transmission and reception.

Japanese Laid-open Patent Application Publication No. JP 2003-346107 published on Dec. 15, 2003 describes an article management system with a wireless article management tag. The wireless article management tag includes a transmitting and receiving antenna, a trigger circuit having a vibration sensor built therein, a microcomputer which controls operations of respective portions, a semiconductor switch, a transmitting and receiving circuit which performs processing for transmitting and receiving RF signals, a battery which supplies operating electric power to respective portions, and a buzzer which outputs a warning sound. When no vibration is sensed, the electric power is not supplied to the transmitting and receiving circuit, so that the microcomputer becomes in a sleep mode. When a vibration is sensed, the microcomputer becomes in a normal operation mode, and the electric power is supplied to the transmitting and receiving circuit. Thereby, the battery power consumption is reduced, and also the article management becomes reliable.

### SUMMARY OF THE INVENTION

According to an aspect of the embodiment, an information processing apparatus includes: a physical quantity detector unit which transforms a physical quantity into an electric signal and provides a detected value represented by the electric signal; a physical quantity determiner unit which determines whether the detected value provided by the physical value quantity detector unit is larger than a given threshold value; a timer unit which measures a time period during which it continues to be determined that the detected value is not larger than the given threshold value, in response to the determination that the detected value is not larger than the given threshold value after it is determined by the physical quantity determiner unit that the detected value is larger than the given threshold; a transmitter unit which transmits a request signal for requesting transmission of data, in response to the time period measured by the timer unit transcending a first given time threshold; and a receiver unit which receives transmitted data which is transmitted in response to the request signal.

According to another aspect of the embodiment, a program stored on a storage medium is provided for realizing the information processing device.

According to a further aspect of the embodiment, a transceiver circuit is provided for use in the information processing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates configurations of an active-type RF ID tag as an active-type contactless information storage device and of a reader/writer device;

FIG. 2A illustrates a time chart of processing for transmission for an RF signal carrying a tag information request command (CMD) transmitted from the reader/writer device, FIG. 2B illustrates a time chart of a receive ready state and of processing for reception of a received RF signal in the reader/writer device, and FIG. 2C illustrates a time chart of carrier sensing, processing for reception of received RF signals, and processing for transmission of an RF signal carrying a response in the case of successful authentication, in the active-type RF ID tag;

FIG. 3 illustrates a flow chart for the processing performed by the reader/writer device;

FIGS. 4A and 4B illustrate a flow chart for the processing performed by the active-type RF ID tag;

FIG. 5 illustrates a configuration of an active-type RF ID tag as an active-type contactless information storage device, which is modified to detect a physical quantity value, such as a temperature, and accumulatively store such detected quantity values;

FIGS. 6A and 6B illustrate time charts of detection or sensing of a physical quantity or state, comparison, carrier sensing, writing data of a detected quantity value into the memory, processing for reception of received RF signals, reading the stored detected value data from the memory, and processing for transmission of an RF signal carrying a response, in the active-type RF ID tag;

FIG. 7A illustrates active-type RF ID tags and a contactless reader/writer device (R/W), which are used for quality management of beer to be provided to customers in a combination of a beer server, a beer barrel or tank, a cleaning water barrel or tank, and a gas canister, in accordance with an embodiment of the present invention;

FIG. 7B illustrates frequencies of RF signals to be transmitted and received between the RF ID tags and the reader/writer (R/W) devices;

FIG. 8 illustrates modification of the reader/writer device of FIG. 1, and illustrates a configuration of the reader/writer device of FIGS. 7A and 7B;

FIGS. 9A-9C illustrate exemplary frame structures which include respective different commands to be transmitted by the reader/writer devices;

FIG. 10A illustrates a time chart of processing for transmission for an RF signal carrying a write-ID request command (CMD) transmitted from the reader/writer device, FIG. 10B illustrates a time chart of a receive ready state and of processing for reception of a received RF signal in the reader/writer device, FIG. 10C illustrates resultant determination of a detected value of a sensor by a determiner unit, FIG. 10D illustrates the detected value of the sensor, and FIG. 10E illustrates a time chart of carrier sensing, processing for detecting an ambient temperature, reading detected value data and writing the data into the memory, processing for reception of a received RF signal, reading the stored detected value data from the memory, and processing for transmission of an RF signal carrying a response with a tag ID, in each of the active-type RF ID tags;

FIG. 11 illustrates an operation mode or state transition diagram of the reader/writer device, which is used by the mode setter unit of the control unit;

FIG. 12 illustrates a flow chart for the operation of the reader/writer device that is controlled by the mode setter unit of the control unit in accordance with the operation mode or state transition diagram of FIG. 11;

FIG. 13 illustrates another operation mode or state transition diagram of the reader/writer device, which is used by the mode setter unit of the control unit;

FIG. 14 illustrates a flow chart for the operation of the reader/writer device that is controlled by the mode setter unit of the control unit in accordance with the operation mode or state transition diagram of FIG. 13;

FIG. 15 illustrates a flow chart for the processing in the transmit mode of operation, which is performed by the reader/writer device;

FIGS. 16A-16C illustrate a flow chart for processing which is executed by the active-type RF ID tag; and

FIG. 17 illustrates a flow chart for the process of Step 419 of FIG. 12 or FIG. 14 described below, which is executed by the mode setter unit.

### DETAILED DESCRIPTION OF THE PREFERRED EMBODIMENTS

The inventors have recognized that a continuously operated reader/writer device with a battery may undesirably and repeatedly transmit and receive RF signals carrying data to and from one RF ID tag, which may undesirably shorten the run time of the battery.

It is an object in one aspect of the embodiment to reduce power consumption of an information processing device.

It is another object of another aspect of the embodiment to allow an information processing device to operate in accordance with a detected physical quantity.

According to the aspects of the embodiment, an information processing device can reduce its power consumption, and an information processing device is allowed to operate in accordance with a detected physical quantity.

Preferred embodiments of the present invention will be described with reference to the accompanying drawings. Throughout the drawings, similar symbols and numerals indicate similar items and functions.

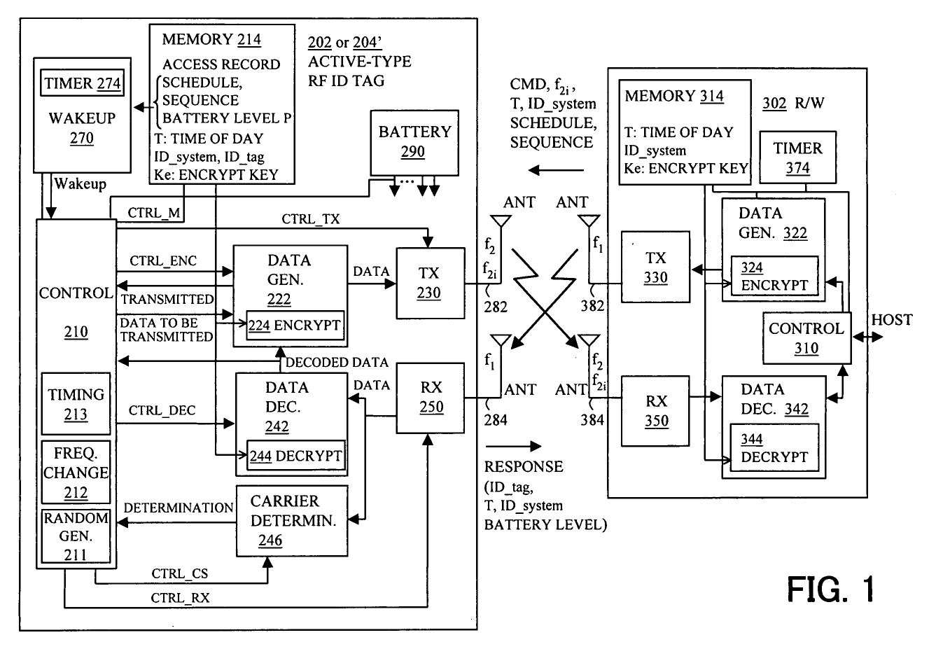

FIG. 1 illustrates configurations of an active-type RF ID tag 202 as an active-type contactless information storage device and of a reader/writer device 302. As an active-type contactless information storage device, a contactless IC card having a configuration similar to that of the active-type RF ID tag 202 may be used in place of the active-type RF ID tag 202. In FIG. 1, data transmitted between the RF ID tag 202 and the reader/writer device 302 is encrypted, and the transmitted data is received and decrypted for authentication. Alternatively, authentication may not be performed for the received data, and the transmitted data may not be encrypted.

The active-type RF ID tag 202 includes a control unit 210, a memory 214, a data generation unit 222, a transmitter unit (TX) 230, a receiver unit (RX) 250, a data decoding unit 242, a carrier determination unit 246, a wakeup unit 270, a transmitting antenna (ANT) 282, a receiving antenna (ANT) 284, and a battery 290.

The data generation unit 222 encrypts data such as a tag ID (ID_tag) stored in the memory 214, and encodes the encrypted data, to thereby generate encoded data. The transmitter unit (TX) 230 modulates a carrier with the encoded data of a baseband received from the data generation unit 222, and then transmits an RF signal at a frequency f₂ or RF signals at different frequencies f₂ᵢ (i=1, 2, . . . , n).

The receiver unit (RX) 250 receives and demodulates an RF signal at a frequency f₁, to thereby reproduce baseband encoded data, and also generates data indicative of the carrier intensity of the received RF signal.

The data decoding unit 242 decodes the encoded data received from the receiver unit 250, and decrypts the decoded data to thereby generate decrypted data. The carrier determination unit 246 determines the presence or absence of a received RF signal carrier in accordance with the data indicative of the carrier intensity.

The wakeup unit 270 generates a wakeup signal in accordance with a time control sequence, which has been set up beforehand.

The frequencies f₁ and f₂ may be 300 MHz and 301 MHz, respectively, for example. The frequencies f₂ᵢ may be 301 MHz, 302 MHz, . . . , 305 MHz, for example. The transmission output power of the transmitter unit (TX) 230 may be one (1) mW, for example.

The transmitting antenna (ANT) 282 is coupled to the transmitter unit 230. The receiving antenna (ANT) 284 is coupled to the receiver unit 250. Alternatively, the antennas 282 and 284 may be composed of a single antenna.

The control unit 210 includes a random number generator 211, a frequency changing unit 212, and a timing unit 213.

The random number generator 211 generates a random number for selecting one of time slots for transmission.

The frequency changing unit 212 changes the transmitting frequency f₂ᵢ. The timing unit 213 adjusts a timing for transmission.

The battery 290 supplies power to the elements 210-270 and the like of the RF ID tag 202.

The control unit 210 is constantly in an active state after power activation of the RF ID tag 202. The control unit 210 provides a memory control signal CTRL_M, a data generation control signal CTRL_ENC, and a transmission control signal CTRL_TX to the memory 214, the data generation unit 222, and the transmitter unit 230, respectively. The control unit 210 further provides a reception control signal CTRL_RX, and a data decoding control signal CTRL_DEC to the receiver unit 250, and the data decoding unit 242, respectively. The control unit 210 further provides a carrier determination control signal CTRL_CS and a wakeup unit control signal to the carrier determination unit 246, and the wakeup unit 270, respectively. The control unit 210 may be a microprocessor or microcomputer that operates in accordance with a stored program.

The memory 214 may store information, such as the tag ID (ID_tag) of the RF ID tag 202, a system ID (ID_system) and an encryption/decryption key Ke for authentication, the current date and time-of-day information T, and records of accesses performed by the reader/writer device 302. The memory 214 may store further information, such as a control schedule and a time control sequence of the wakeup unit 270, the current remaining power level of the battery 290, a cycle period Tcs for sensing a carrier, a time period of processing for reception, and a time period of transmission.

These pieces of information are transmitted to the RF ID tag 202 by the reader/writer device 302 beforehand, and then written into the memory 214 by the control unit 210 beforehand. These pieces of information in the memory 214 are stored and updated under the control of the control unit 210.

The memory 214 provides the current date and time-of-day information T, the system ID and the encryption/decryption key Ke to the data generation unit 222 and the data decoding unit 242.

The system ID is indicative of a common ID shared by a group of the reader/writer device 302 and a plurality of RF ID tags including the RF ID tag 202. The system ID may be an ID of the reader/writer device 302.

The data generation unit 222 includes an encryption unit 224, which encrypts the data to be transmitted, with the encryption key Ke stored in the memory 214 in accordance with a given or applicable cryptosystem. The data decoding unit 242 includes a decryption unit 244, which decrypts the received data with the encryption/decryption key Ke in accordance with the given cryptosystem. The common key cryptosystem is employed as the given cryptosystem herein. Alternatively, the public key cryptosystem may be employed.

The wakeup unit 270 includes a timer 274 which measures time and thereby generates a date and a time of day. The wakeup unit 270 is constantly in an active state after the power activation of the RF ID tag 202. In accordance with the date and time of day of the timer 274 and with the control schedule and the time control sequence read out from the memory 214 and set up beforehand, the wakeup unit 270 provides a wakeup signal to the control unit 210 in a given cycle Tcs for sensing a carrier, for example, of two seconds. The control unit 210 corrects the date and time of day of the timer 274 in accordance with the current date and time of day information T in the memory 214, and then writes and updates the current date and time of day T generated by the timer 274 in the memory 214.

The data generation unit 222 generates data in a given format including the tag ID (ID_tag) stored in the memory 214 and the like, encrypts the generated data in accordance with the given cryptosystem, then encodes the encrypted data in accordance with a given or applicable encoding scheme, and then provides the encoded data to the transmitter unit 230. The data may include the remaining battery power level and the access records.

The data decoding unit 242 decodes the received encoded data in accordance with the given encoding scheme, and decrypts the decoded data to thereby generate decrypted data. The data decoding unit 242 then provides the decrypted data to the data generation unit 222 and to the control unit 210.

The carrier determination unit 246 receives, from the receiver unit 250, the data indicative of the power intensity of the received RF signal carrier, and accordingly determines the presence or absence of a received carrier. The carrier determination unit 246 then provides the resultant determination to the control unit 210.

The reader/writer device 302 includes a control unit 310, a memory 314, a data generation unit 322, a transmitter unit (TX) 330, a receiver unit (RX) 350, a data decoding unit 342, a timer 374 which measures time and thereby generates a date and a time of day, a transmitting antenna (ANT) 382, and a receiving antenna (ANT) 384.

The control unit 310 transmits and receives data to and from a host computer or a mobile or portable terminal (not shown). The data generation unit 322 generates data in a given format including a command (CMD) and the like received from the control unit 310. The data generation unit 322 then encrypts the generated data, and then encodes the encrypted data, to thereby generate encoded data.

The transmitter unit (TX) 330 modulates the carrier with the encoded data of a baseband received from the data generation unit 322, and then transmits an RF signal at the frequency f₁. The transmission output power of the transmitter unit (TX) 330 may be one (1) mW, for example.

The receiver unit (RX) 350 receives and demodulates an RF signal at a frequency f₂ or RF signals at frequencies f₂₁-f₂ₙ, to thereby reproduce encoded data. The data decoding unit 342 decodes the encoded data received from the receiver unit 350 to thereby generate baseband decoded data, and then decrypts the decoded data. The receiver unit 350 then provides the decrypted data to the control unit 310.

The transmitting antenna (ANT) 382 is coupled to the transmitter unit 330. The receiving antenna (ANT) 384 is coupled to the receiver unit 350. Alternatively, the antennas 382 and 384 may be composed of a single antenna.

The memory 314 of the reader/writer device 302 stores the current date and time-of-day information T for authentication, the system ID (ID_system) for authentication, and an encryption/decryption key Ke. The data generation unit 322 includes an encryption unit 324, which encrypts the data to be transmitted, with the encryption key Ke stored in the memory 314 in accordance with the given cryptosystem. The data decoding unit 342 includes a decryption unit 344, which decrypts the received data with the encryption/decryption key Ke in accordance with the given cryptosystem.

When the control unit 310 receives a command such as a tag ID or information request command (referred to simply as a tag information request command hereinafter) from the host computer or a mobile or portable terminal, it provides data including the command to the data generation unit 322. The data may include the transmission frequency f₂ or f₂ᵢ to be used in the RF ID tag 202, the reference current date and time-of-day information T, and a control schedule and a time control sequence which are new or updated. The command may include an instruction of correcting or updating the time of the timer 274, in addition to the current date and time-of-day information T. Further, the command may include an instruction of correcting or updating the schedule or the sequence stored in the memory 214, in addition to the control schedule or the time control sequence which are new or updated.

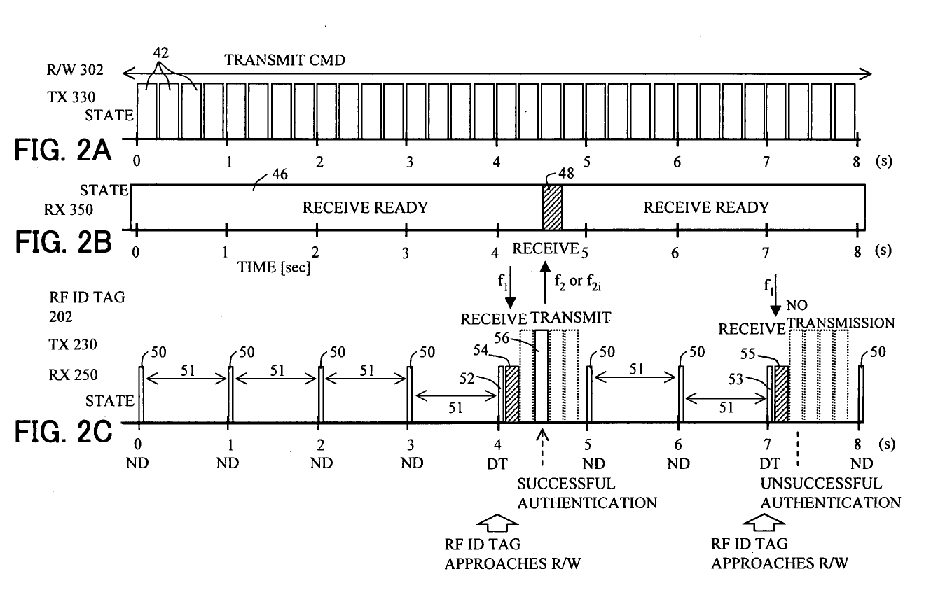

FIG. 2A illustrates a time chart of processing for transmission 42 for an RF signal carrying a tag information request command (CMD) transmitted from the reader/writer device 302. FIG. 2B illustrates a time chart of a receive ready state 46 and of processing for reception 48 of a received RF signal in the reader/writer device 302. FIG. 2C illustrates a time chart of carrier sensing 50, 52 and 53, processing for reception 54 and 55 of received RF signals, and processing for transmission 56 of an RF signal carrying a response in the case of successful authentication, in the active-type RF ID tag 202.

Referring to FIG. 2A, the data generation unit 322 of the reader/writer device 302 generates data including a tag information request command for the RF ID tag that is received from the control unit 310, encrypts the data, and encodes the encrypted data to thereby generate encoded encrypted data. The transmitter unit 330 cyclically transmits the RF signal carrying the command in the successive time slots at short intervals in the processing for transmission 42.

Referring to FIG. 2C, in the active-type RF ID tag 202, in response to a wakeup signal from the wakeup unit 274, the control unit 210 enables the receiver unit 250 and the carrier determination unit 246 in the periods of time for carrier sensing 50 and 52 with a given duration, for example of approximately 1-10 ms, occurring in a fixed cycle Tcs, for example of two seconds. This causes the receiver unit 250 to enter into a receive ready state. Then the enabled carrier determination unit 246 determines the presence or absence of a received carrier, in accordance with the data received from the receiver unit 250 indicating the power intensity of the received RF signal carrier. When the RF ID tag 202 is not located near the reader/writer device 302, the carrier determination unit 246 detects no carrier (ND), and hence determines the absence of a carrier.

In a period of time 51 intervening between two adjacent carrier sensing time periods 50, the RF ID tag 202 enters into a sleep mode of operation, during which only the control unit 210 and the wakeup unit 270 are enabled or powered on, while the other elements 214-250 are disabled or powered down. The time length of the sleep period of time 51 may be shorter than the length of time between the ending time of a carrier sensing time period 50 and the starting time of the next carrier sensing time period 50. Thus, the RF ID tag 202 may exit the sleep mode of operation before the starting time of the carrier sensing, which allows earlier processing, such as storing ambient environmental data or information or the like, which may be acquired by a physical sensor. This may also reduce power consumption of the RF ID tag for transmission, reception or the like.

When the RF ID tag 202 approaches the reader/writer device 302 so that the receiver unit 250 of the RF ID tag 202 receives an RF signal, the carrier determination unit 246 detects the carrier of the RF signal (DT) in the time period for carrier sensing 52, and hence determines the presence of a carrier.

In response to the resultant determination of the presence of a carrier, the receiver unit 250 and the data decoding unit 242 are enabled in the time period of the subsequent processing for reception 54 with a given duration, for example, of 100 ms.

The enabled receiver unit 250 receives and demodulates the RF signal to thereby reproduce encoded encrypted data including a command. The enabled data decoding unit 242 decodes the data, then decrypts the decoded data, then obtains the command from the data, and then provides the command to the control unit 210.

The control unit 210 authenticates the reader/writer device 302 in accordance with the date and time-of-day information T and the system ID included in the command. When the authentication has been successful, the control unit 210 enables, in response to the command, the data generation unit 222 and the transmitter unit 230 in a time period or slot of processing for transmission 56 selected at random within a given period of time, each time slot having a given duration, for example, of 100 ms.

The enabled data generation unit 222 encrypts data including required information, such as the tag ID (ID_tag), the date and time-of-day information T, the system ID (ID_system) and the like retrieved from the memory 214, and then encodes the encrypted data. The required information may include other information, such as commodity contents of a package and the number and state of the content items, a sender, transportation, a route and a destination. The enabled transmitter unit 230 modulates the carrier with the encoded response data including the tag ID for transmitting the RF signal carrying the response data.

On the other hand, when the authentication has been unsuccessful, the processing is terminated without generating or transmitting the data.

Referring to FIG. 2B, the receiver unit 350 of the reader/writer device 302 is constantly in the receive ready state 46. When the RF ID tag 202 approaches the reader/writer device 302 so that the receiver unit 350 receives an RF signal, the receiver unit 350 demodulates the received RF signal in the time period of processing for reception 48, and then reproduces encoded encrypted data.

The data decoding unit 342 decodes the encoded encrypted data, then decrypts the decoded encrypted data to thereby reproduce the response data including the tag ID, and then provides the reproduced response to the control unit 310.

In response to the received and reproduced response, the control unit 310 authenticates the RF ID tag 202 in accordance with the date and time-of-day information T and the system ID included in the response, and then provides the tag ID and other information to the host computer or the mobile terminal.

The host computer or the mobile terminal processes the tag ID to use for monitoring and managing the article distribution or the persons.

In general, the total time during which the RF ID tag 202 is not located near the reader/writer device 302 is much longer than the time during which the RF ID tag 202 is located near the reader/writer device 302. Thus, the active-type RF ID tag 202 is in a sleep mode of operation for the most period of time.

This significantly reduces the power consumption of the active-type RF ID tag 202, and hence significantly increases the run time of the battery 290.

In general, when the reader/writer device 302 and the RF ID tag 202 encrypt the data to be transmitted and perform mutual authentication in accordance with the date and time-of-day information T and the system ID as described above, the data transmitted by the reader/writer device 302 and the RF ID tag 202, which may be intercepted by a third party, has little risk of being decrypted and used improperly. This enhances the security of the reader/writer device 302 and the RF ID tag 202.

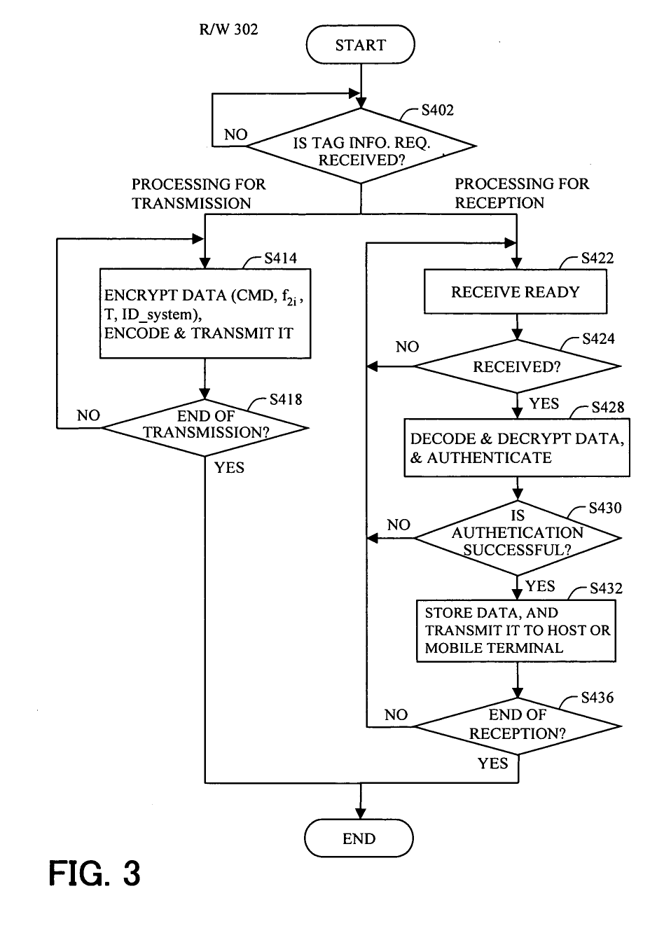

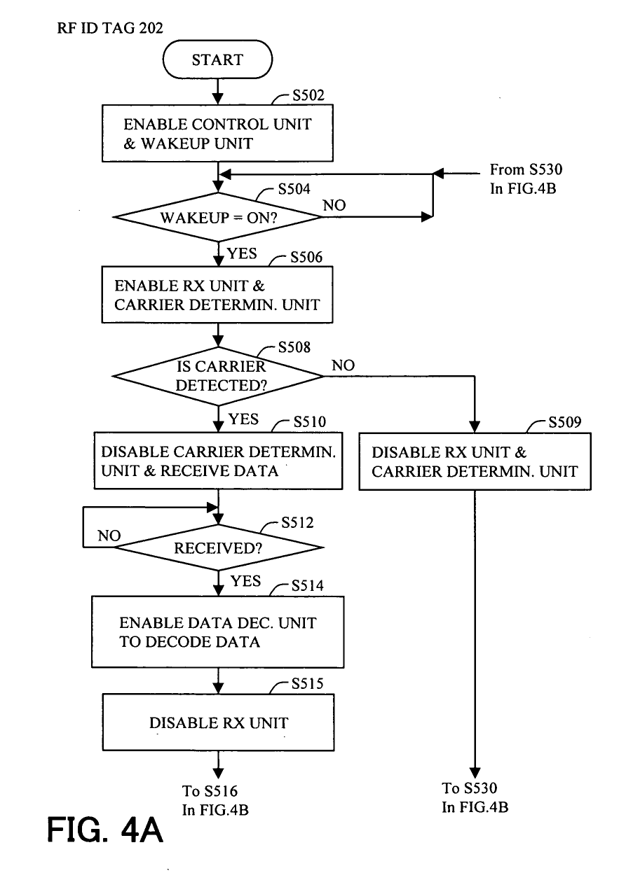

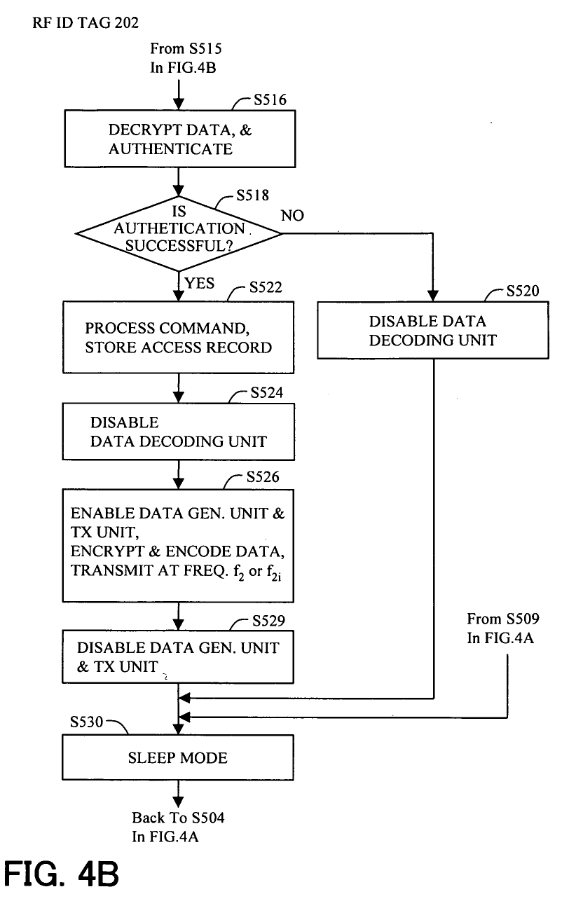

FIG. 3 illustrates a flow chart for the processing performed by the reader/writer device 302. FIGS. 4A and 4B illustrate a flow chart for the processing performed by the active-type RF ID tag 202.

Referring to FIG. 3, at Step 402, the control unit 310 of the reader/writer device 302 determines whether a tag information request command received from the host computer or the mobile terminal has been detected. Step 402 is repeated until a tag information request command is detected. When a tag information request command is detected, the procedure proceeds to Step 414 for processing for transmission and to Step 422 for processing for reception.

At Step 414, the control unit 310 provides the tag information request command and the related information to the data generation unit 322. The data generation unit 322 encrypts data including the tag information request command received from the control unit 310 and including the current date and time-of-day information T, the system ID (ID_system) and an ID of the reader/writer device 302 retrieved from the memory 314, with the encryption key Ke retrieved from the memory 314 in accordance with a given cryptosystem. The given cryptosystem may be the DES (Data Description Standard), the Triple DES or the AES (Advanced Encryption Standard), for example. The data generation unit 322 then encodes the encrypted data to thereby generate encoded data in accordance with a given encoding scheme, such as the NRZ (Non-Return-to-Zero) encoding system or the Manchester encoding system. The transmitter unit 330 modulates the carrier with the encoded data in the time slot of processing for transmission 42 of FIG. 2A, and then transmits the RF signal at a frequency f₁.

The control unit 310 may incorporate, into the tag information request command, data for specifying the transmission frequency f₂ or the variable transmission frequencies f₂ᵢ used for a response to the tag information request command, and data indicative of time of day or time slots to be used for the variable transmission frequencies f₂ᵢ as well as data indicative of the current date and time of day T, and a control schedule and a time control sequence.

The reader/writer device 302 may change the frequencies f₂ᵢ in a time division manner, selecting one of the frequencies for every set of commands in respective transmission cycles t_{RW-CY}, the number of which may correspond, for example, to the time length of one or more cycles for sensing a carrier.

This reduces the probability of collision between response RF signals transmitted from a plurality of RF ID tags which simultaneously approach the reader/writer device 302. This increases the number of RF ID tags that the reader/writer device 302 can simultaneously identify.

At Step 418, the control unit 210 determines whether the processing for data transmission is to be terminated. If it is determined that the data transmission is to be terminated, the procedure exits this routine. If it is determined that the processing for data transmission is to be continued, the procedure returns to Step 414. In FIG. 2A, the data transmission is repeated and continued.

Referring to FIG. 4A, at Step 502, when the RF ID tag 202 is activated, the control unit 210 and the wakeup unit 270 are enabled. Once the RF ID tag 202 is activated, the control unit 210 and the wakeup unit 270 are constantly enabled, and hence in an active state. In accordance with the timer 274 and with the time control sequence, the wakeup unit 270 provides the control unit 210 with a wakeup signal indicative of the timing for carrier sensing of a received RF signal in a given cycle Tcs. At Step 504, the control unit 210 determines whether the wakeup signal received from the wakeup unit 270 indicates an ON state. The control unit 210 repeats the Step 504 until the wakeup signal goes to the ON state.

If it is determined at Step 504 that the wakeup signal indicates the ON state, then the control unit 210 at Step 506 enables the receiver unit 250 and the carrier determination unit 246 for a short duration, for example, of approximately 1-10 ms. Then, the enabled receiver unit 250 enters into the state of being ready to receive an RF signal. In accordance with the data received from the receiver unit 250 that is indicative of the received carrier power, the enabled carrier determination unit 246 determines the presence or absence of a received RF signal carrier, and then provides the resultant determination to the control unit 210. At Step 508, in accordance with the resultant determination, the control unit 210 determines whether a carrier is detected. If it is determined that no carrier is detected, the control unit 210 at Step 509 disables the receiver unit 250 and carrier determination unit 246. After that, the procedure proceeds to Step 530.

If it is determined at Step 508 that a carrier is detected, then the control unit 210 at Step 510 disables carrier determination unit 246 and continues to enable the receiver unit 250 in a further given duration, for example of 100-200 ms, to receive an RF signal at a frequency f₁ carrying a command from the reader/writer device 302 (reception 54 in FIG. 3C), and then demodulates the received RF signal. At Step 512, the control unit 210 determines whether the receiver unit 250 has received the RF signal. The Step 512 is repeated until the reception of the RF signal is completed.

If it is determined at Step 512 that the RF signal has been received, then the control unit 210 at Step 514 enables the data decoding unit 242. The enabled data decoding unit 242 receives the received data from the receiver unit 250 under the control of the control unit 210, and then decodes the data in accordance with the given encoding scheme. At Step 515, the control unit 210 disables the receiver unit 250.

Referring to FIG. 4B, at Step 516, under the control of the control unit 210, the data decoding unit 242 decrypts the decoded data with the encryption/decryption key Ke retrieved from the memory 214 in accordance with the given cryptosystem, and then provides the decrypted data including the command, the tag ID (ID_tag), the date and time-of-day information T, and the system ID (ID_system) to the control unit 210. The data may include a control schedule and a time control sequence. Upon receiving the data, the control unit 210 compares the decrypted date and time-of-day T and system ID with the stored date and time-of-day T and system ID in the memory 214, to determine whether the decrypted time information and ID match with the stored time information and ID, in order to authenticate the reader/writer device 302.

At Step 518, the control unit 210 determines whether the authentication has been successful. If it is determined that the authentication has been unsuccessful, the control unit 210 at Step 520 disables the data decoding unit 242. Then, the procedure proceeds to Step 530.

If it is determined at Step 518 that the authentication has been successful, the control unit 210 at Step 522 receives the decrypted decoded data including the tag information request command from the data decoding unit 242, then processes the received command included in the decrypted data, and then stores into the memory 214 the record of access performed by the reader/writer device 302.

When a time correction command and the current date and time-of-day information T are included in the received data, the control unit 210 corrects or updates the time of the timer 274 of the wakeup unit 270 into the time T.

At Step 524, the control unit 210 disables the data decoding unit 242. At Step 526, in accordance with the tag information request command, the control unit 210 enables the data generation unit 222 and the transmitter unit 230 in a time slot selected at random in accordance with a random number from a given number of time slots within a given period of time. This selected time slot corresponds to the time period of the processing for transmission 56 of FIG. 2C.

The data generation unit 222 encrypts data including the tag ID (ID_tag) of the RF ID tag 202, the date and time-of-day information T, the system ID (ID_system) and the ID of the reader/writer device 302 read out from the memory 214, with the encryption key Ke in accordance with the given cryptosystem. The data generation unit 222 then encodes the encrypted data in accordance with the given encoding scheme, and then provides the encoded encrypted data to the transmitter unit 230.

The enabled transmitter unit 230 modulates the carrier with the encoded encrypted data, and then transmits the RF signal at a frequency f₂ or f₂ᵢ via the antenna 284 (transmission 56 in FIG. 2C). The frequency f₂ᵢ is changed by the frequency changing unit 212 of the control unit 210. The timing unit 213 adjusts a plurality of successive cycle time slots to occur in a given cycle.

At Step 529, the control unit 210 disables the data generation unit 222 and the transmitter unit 230. At Step 530, the control unit 210 causes the RF ID tag 202 to enter into the sleep mode of operation. In the sleep mode of operation, basically, only the control unit 210 and the wakeup unit 270 continue to stay in the enabled state, while the other elements 214-250 are disabled.

Referring back to FIG. 3, at Step 422, the control unit 310 enables the receiver unit 350 to enter into the receive ready state. The receiver unit 350 waits for the reception of an RF signal at a frequency f₂ (receive ready 46), and then receives an RF signal (processing for reception 48). At Step 424, the control unit 310 determines whether the receiver unit 350 has received the RF signal. Steps 424-424 are repeated until the reception is completed. If it is determined that the RF signal has been received, the procedure proceeds to Step 428.

At Step 428, the receiver unit 350 provides the received data to the data decoding unit 342. The data decoding unit 342 decodes the received data in accordance with the given encoding scheme, then decrypts the decoded data in accordance with the given cryptosystem, and then provides the determination of data reception and the decrypted data to the control unit 310. The control unit 310 compares the decrypted time T and system ID with the stored time T and system ID in the memory 314, to determine whether the decrypted time information and ID match with the stored time information and ID, in order to authenticate the RF ID tag 202. Even if there is an error between the received date and time-of-day information T and the stored date and time-of-day information T that falls within a given range (e.g., ±0.5 seconds) in the control unit 210 of the RF ID tag 202 and in the control unit 310 of the reader/writer device 302, they may determine that the received date and time-of-day information matches with the stored date and time-of-day information.

At Step 430, the control unit 310 determines whether the authentication has been successful. If it is determined that the authentication has been unsuccessful, the procedure returns to Step 422. If it is determined that the authentication has been successful, the procedure proceeds to Step 432.

At Step 433, the control unit 310 transmits the decoded data to the host computer or the mobile terminal. At Step 436, the control unit 310 determines whether the data receive ready state is to be terminated. If it is determined that the data receive ready state is to be terminated, the procedure exits the routine of FIG. 3. If it is determined that the data receive ready state is to be continued, the procedure returns to Step 422. In FIG. 2B, the data receive ready state is repeated and continued.

Thus, the reader/writer device 302 transmits the RF signal cyclically at sufficiently short intervals, and is constantly in the ready state to receive the RF signal. This significantly reduces the carrier sensing time of the RF ID tag 202.

Under the control of the control unit 210, the wakeup unit 270 may generate a wakeup signal depending on the remaining power level P of the battery 290 stored in the memory 214. In this case, when the remaining battery power level P is sufficiently high, the carrier sensing may be performed in a relatively short cycle (e.g., of one second). On the other hand, when the remaining battery power level P goes below a threshold Pth, the carrier sensing may be performed in a relatively long cycle (e.g., of two seconds).

The configurations and operations of the active-type RF ID tag 202 and the reader/writer device 302 described above are partly disclosed by the inventors of the present invention and other persons in the US Patent Application Publication No. 2006/276206 (A1), the entirety of which is incorporated herein by reference.

An active-type RF ID tag may have a detector or sensor, which detects or senses a physical quantity or physical state in its ambient environment, and may store records of the detected quantity values or states. A reader/writer device can read the RF ID tag and collect data of such physical quantity values or states together with a tag ID of the RF ID tag. The RF ID tag may be adapted to skip recording current detected data which has a small difference from a previously recorded detected data, which difference is below or within a difference threshold, so that power required for recording the data can be reduced, a battery run time can be extended, and the requirements of the memory capacity for recording the data can be reduced.

The active-type RF ID tag 202 of FIGS. 1 through 4B may be provided with a detector or sensor for detecting a physical quantity or state value in its ambient environment, and store records of data of values detected by the detector or sensor. In this case, it may be contemplated that the wakeup unit 270 may generate a wakeup signal in a given cycle and, in response, the detector or sensor may be temporally enabled to detect a physical quantity value, which may be stored into the memory 214 in the given cycle. A large amount of the detected data stored in the memory 214 over a long period of time can be read out by the reader/writer device 302 at a later time.

As described above, the wakeup unit 270 of the RF ID tag 202 may generate a wakeup signal depending on the remaining power level P of the battery 290 stored in the memory 214. When the remaining battery power level P is sufficiently high, the physical quantity detection and/or the carrier sensing may be performed in a relatively short cycle. When the remaining battery power level P goes below a threshold Pth, the carrier sensing may be performed in a relatively long cycle. Thus, the run time of the RF ID tag 202 can be extended by reducing the rate or the number of times per unit time for the carrier sensing, before the power shortage of the battery 290 occurs and causes the RF ID tag 202 to cease the carrier sensing, and data transmission and reception. On the other hand, accuracy of data, which is acquired by the detector or sensor of the RF ID tag 202 and received by the reader/writer device 302, may be secured by increasing the rate or the number of times per unit time for the physical quantity detection and/or the carrier sensing, and possible subsequent command reception and data transmission in the RF ID tag 202, while the battery 290 has a sufficient power. Thus, there may be a tradeoff between the secured accuracy of acquired data, and the intervals of the physical quantity detection and/or the carrier sensing in the RF ID tag 202 for reducing the power consumption. This relation can be appropriately determined by controlling the intervals of the physical quantity detection and/or the carrier sensing, depending on the remaining power of the battery 290.

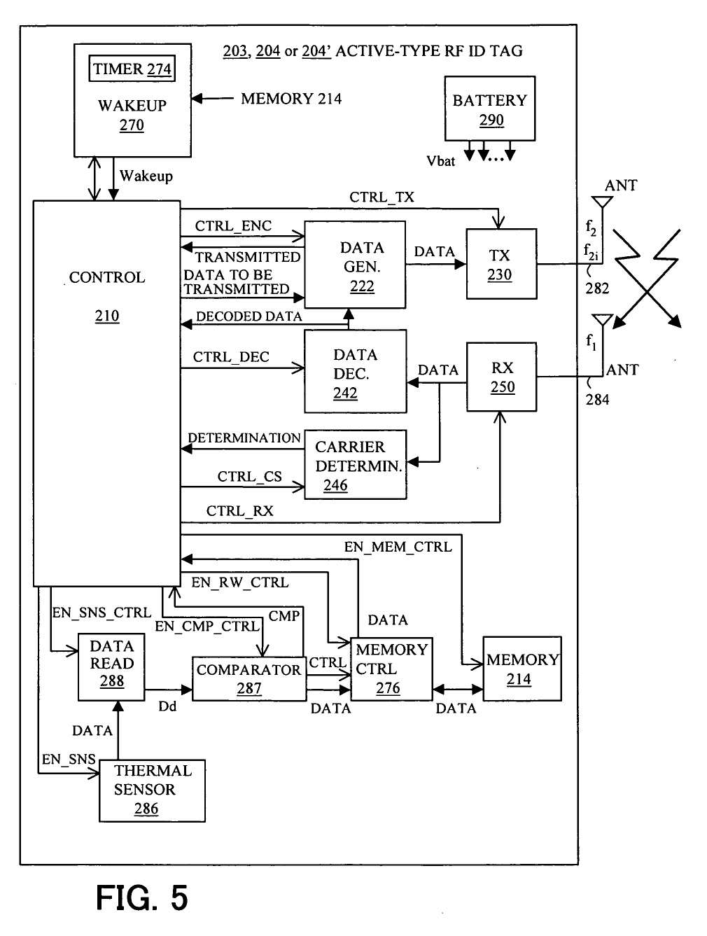

FIG. 5 illustrates a configuration of an active-type RF ID tag 203 as an active-type contactless information storage device, which is modified to detect a physical quantity value, such as a temperature, and accumulatively store such detected quantity values. The reader/writer device 302 of FIG. 1 may be used to read information in the RF ID tag 203.

In addition to the elements 210-213, 222-274 and 290 of the RF ID tag 202 of FIG. 1, the RF ID tag 203 includes a memory control unit 276, a thermal or temperature sensor 286, a detected-data reading unit or acquisition unit 288, and a comparator unit 287. The detected-data reading unit 288 acquires and holds a value detected or sensed by the thermal sensor 286. The other elements of the RF ID tag 203 are similar to those of the RF ID tag 202 of FIG. 1. The battery 290 supplies power to the elements 210-276, 286, 288, 287 and the like of the RF ID tag 203.

The elements 222-246, 270, 276, 287 and 288 may be implemented in the form of hardware, as separate circuits or as a part of the control unit 210. Alternatively, at least a part of the elements 222-246, 270, 276, 287 and 288 may be implemented in the form of software, as functions of the control unit 210 which operate in accordance with programs stored in a memory (214).

In response to a wakeup signal from the wakeup unit 270, the control unit 210 provides control signals EN_MEM_CTRL, EN_RW_CTRL, EN_CMP_CTRL, EN_SNS, and EN_SNS_CTRL, for enabling and disabling the memory 214, the memory control unit 276, the comparator unit 287, the thermal sensor 286, and the detected-data reading unit 288, respectively.

In response to a tag information request command CMD from the reader/writer device 302, the control unit 210 controls the memory control unit 276 to read out a file of stored data DATA of the detected values which has been accumulatively stored in the memory 214. Other elements and operation of the RF ID tag 203 are similar to those of the RF ID tag 202 of FIG. 1.

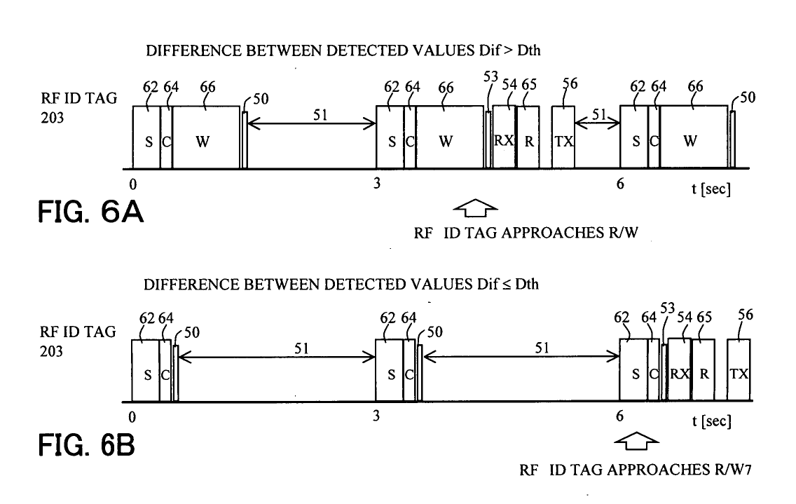

FIGS. 6A and 6B illustrate time charts of detection or sensing 62 of a physical quantity or state such as an ambient temperature, comparison 64, carrier sensing 50 and 53, writing data of a detected physical quantity value 66 into the memory 214, processing for reception 54 of received RF signals, reading the stored detected value data 65 from the memory 214, and processing for transmission 56 of an RF signal carrying a response, in the active-type RF ID tag 203.

In the RF ID tag 203, in response to the wakeup signal from the wakeup unit 270, the control unit 210 enables and disables either the thermal sensor 286 and the detected-data reading unit 288, or the receiver unit 250 and the carrier determination unit 246.

The comparator unit 287 obtains data of a detected value Dd of the thermal sensor 286, and stores it into the memory 214 via the memory control unit 176. The control unit 210 controls to cyclically perform the carrier sensing 50 and 53. In response to reception of a tag information request command transmitted by the reader/writer device 302, the control unit 210 transmits a file of the detected value data and the tag ID back to the reader/writer device 302.

Referring to FIG. 6A, in the period of time 62, the control unit 210 of the RF ID tag 203 controls the thermal sensor 286 to detect a value D of a physical quantity, such as an ambient temperature, or a physical state (S), and controls the detected-data reading unit 288 to read current data of the detected value Dc. In the period of time 64, the control unit 210 controls the comparator unit 287 to compare an absolute difference Dif between the current data of the detected value Dc and the previously stored data of the detected value Ds (Dif=|Dc−Ds|) with a given threshold value (Dth) (C). If the absolute difference Dif transcends the threshold value (Dif>Dth), then, in the period of time 66, the comparator unit 287 controls the memory control unit 276 to write the current detected value Dc into the memory 214 (W) to hold the detected value Dc as a new stored value Ds. Then the RF ID tag 203 performs carrier sensing in the periods of time 50 and 53. In the period of time 65, the memory control unit 276 reads out of the memory 214 a file of stored data of the detected values which has been stored or recorded over a given period of time, and then provides the file to the control unit 210.

Referring to FIG. 6B, if the absolute difference Dif between the current detected data Dc and the previous detected data Ds does not transcend the threshold value Dth (i.e., if Dif≦Dth), the comparator unit 287 does not write the detected value Dc into the memory 214, whereby the power consumption for storing data and the requirements of memory capacity of the memory 214 can be reduced. Then the RF ID tag 203 performs carrier sensing in the periods of time 50 and 53. The comparator 287 may be eliminated or bypassed. In this case, the RF ID tag 203 operates according to the time chart of FIG. 6A, but does not operate according to the time chart of FIG. 6B.

Referring to FIGS. 6A and 6B, in the period of time 53, in response to detection of a carrier of an RF signal transmitted by the reader/writer device 302, the RF ID tag 203 receives the transmitted RF signal. In response to the tag information request command carried by the transmitted RF signal, the control unit 210 provides the control signals EN_RW_CTRL and EN_MEM_CTRL to enable the memory control unit 276 and the memory 214 respectively, and reads out the file of data of the stored detected values in the memory 214 together with the tag ID, and transmits them back to the reader/writer device 302.

The inventors have recognized that it is desirable that a reader/writer device is controlled to enter into a sleep state when the reader/writer device is not required to transmit and receive data to and from an RF ID tag, and that the reader/writer device is controlled to operate in a normal state when the reader/writer device is required to transmit and receive data to and from the RF ID tag, whereby the power consumption of the reader/writer device can be reduced.

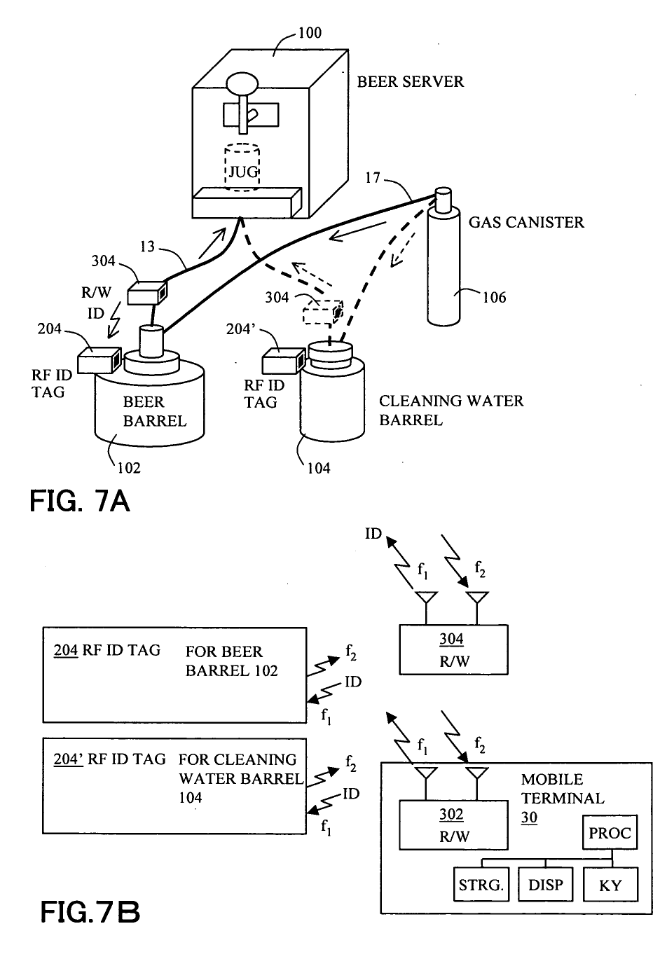

FIG. 7A illustrates active-type RF ID tags 204 and 204′ and a contactless reader/writer device (R/W) 304, which are used for quality management of beer to be provided to customers in a combination of a beer server 100, a beer barrel or tank 102, a cleaning water barrel or tank 104, and a gas canister 106, in accordance with an embodiment of the present invention. FIG. 7B illustrates frequencies of RF signals to be transmitted and received between the RF ID tags 204 and 204′ and the reader/writer (R/W) devices 302 and 304.

The RF ID tags 204 and 204′ may have a configuration and operation similar to those of the RF ID tag 203 of FIG. 5. Alternatively, the RF ID tag 204′ may have a configuration and operation similar to those of the RF ID tag 202 of FIG. 1.

The RF ID tag 204 is used for managing routes, dates and time-of-day information of transportation of the beer barrel 102 carried by a refrigerated transport container for example, and also for tracing the change of the temperature inside the container. A mobile terminal 30 includes a processor PROC, storage STRG, operation keys KY and a display DISP, and has the reader/writer device 302. The mobile terminal 30 (the processor PROC) provides a command and data to the reader/writer device 302, and receives data from the reader/writer device 302 and stores the data into its storage STRG.

The reader/writer device 304 is attached to a beer supply hose or flexible tube 13 at or near its distal end portion. The RF ID tag 204 is attached to the beer barrel 102 near its supply port. The RF ID tag 204′ is attached to the cleaning water barrel 104 near its supply port. Each of the RF ID tags 204 and 204′ has a transmission frequency f₂ and a reception frequency f₁. Each of the reader/writer (R/W) devices 302 and 304 has a transmission frequency f₁ and a reception frequency f₂.

Referring to FIG. 7A, a waiter or waitress may connect the beer supply hose or flexible tube 13 of the beer server 100 to the supply port of the beer barrel 102, and connect a gas supply hose or flexible tube 17 from the gas canister 106 to another port of the beer barrel 102. He or she then may place a jug under a beer supply port of the beer server 100 and turn on a tap of the beer server 100. In response, the gas canister 106 supplies carbon dioxide gas through the gas supply hose 17 to the beer barrel 102, from which the supplied beer flows into the beer server 100. Thus, the beer in the beer barrel 102 flows to the beer server 100 and into the jug.

When the beer barrel 102 becomes emptied, he or she may connect the beer supply hose 13 from the beer server 100 to the supply port or hole of the cleaning water barrel 104, and connect the gas supply hose 17 from the gas canister 106 to the other port or hole of the cleaning water barrel 104, according to an instruction manual. He or she then may place an empty container under the beer supply port of the beer server 100 and turn on the tap of the beer server 100. The gas canister 106 is then caused to supply carbon dioxide gas through the gas supply hose 17 to the cleaning water barrel 104, from which the supplied cleaning water flows into the beer server 100. Thus, the beer supply hose 13 and inner passages of the beer server 100 are cleaned.

The RF ID tag 204 cyclically detects the temperature of the beer barrel 102 in contact or in the neighborhood, and records and cumulatively stores required temperature data with the current date and time of the day. Each of the RF ID tags 204 and 204′ records the ID transmitted by the reader/writer device 304 with the current date and time of the day. Thus, a record of connection of the beer barrel 102 to the beer supply hose 13 together with the date and time-of-day information is stored into the RF ID tag 204, and a record of connection of the cleaning water barrel 104 to the beer supply hose 13 together with the date and time-of-day information is stored into the RF ID tag 204′.

The records of data stored in the RF ID tags 204 and 204′ may be regularly read out by the reader/writer 302 associated with the mobile terminal 30, which may be carried by a delivery person of a beer barrel or may be located at a beer barrel production factory, so that the records of data are stored into the mobile terminal 30 for data collection. Thus, a beer distributor or manager can manage the quality of beer to be provided to customers.

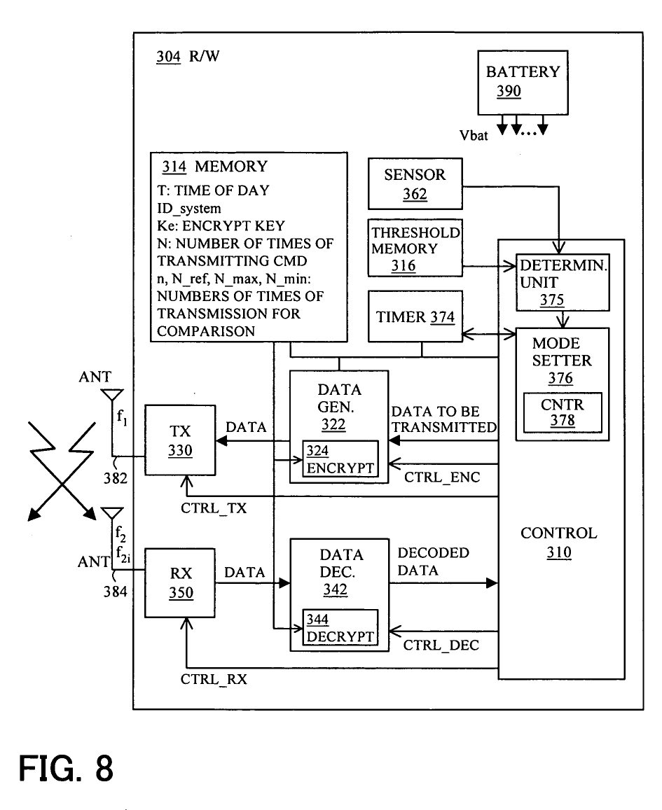

FIG. 8 illustrates modification of the reader/writer device 302 of FIG. 1, and illustrates a configuration of the reader/writer device 304 of FIGS. 7A and 7B.

The reader/writer device 304 includes a threshold memory or storage 316, a sensor 362 for detecting or sensing a physical quantity or state, and a rechargeable or disposable battery 390, in addition to the elements 310, 314, 322-342, and 374-384 of FIG. 1. The threshold memory 316 may be a memory area within the memory 314. The control unit 310 has a determiner unit 375 and a mode setter or control unit 376. The sensor 362 transforms or converts the detected physical quantity or state into an electric signal, and provides the transformed electric signal indicative of a value of the detected physical quantity or state as an output. The reader/writer device 304 may be considered as a transceiver device, or may have a transceiver circuit or device including the elements 310, 314, 316, 322, 330, 342, 350, 374, 382 and 384.

The elements 322-344, 374, 375 and 376 may be implemented in the form of hardware, as separate circuits or as a part of the control unit 310. Alternatively, at least a part of the elements 322-344, 374, 375 and 376 may be implemented in the form of software, as functions of the control unit 310 which operate in accordance with programs stored in a memory (314).

The sensor 362 may be a vibration sensor, an acceleration sensor, a thermal sensor, an ambient light sensor, a human infrared (IR) sensor, or a proximity sensor. In the embodiment, the detection by the sensor 362 is used to enable and disable the reader/writer device 304 to transmit a write-ID request command or a tag information request command and receive a response RF signal.

The vibration sensor or acceleration sensor detects mechanical movement or vibration of the reader/writer device 304 attached to a hose connector or the like to be moved by a user, in order to write an ID of the reader/writer device 304 into an RF ID tag attached to a merchandise article, such as a beer barrel.

The thermal sensor (362) may detect change of an ambient temperature of the reader/writer device 304 from a room temperature to a lower temperature, or from such a lower temperature to the room temperature, in order to write an ID of the reader/writer device 304 into an RF ID tag attached to a merchandise article, which requires temperature control.

The ambient light sensor may detect movement of the reader/writer device 304 from the inside of a shop in a brighter illumination environment to a location near an RF ID tag of a merchandise article in a darker illumination environment, in order to write an ID of the reader/writer device 304 into the RF ID tag.

The human infrared (IR) sensor may detect appearance of a human getting close to the reader/writer device 304, in order to write an ID of the reader/writer device 304 into the RF ID tag attached to a merchandise article.

The proximity sensor may detect appearance of a part of a merchandise article, such as a beer supply port of the beer barrel 102, in proximity to the reader/writer device 304, in order to write an ID of the reader/writer device 304 into an RF ID tag attached to the merchandise article.

In order to acquire a significant detected value, the determiner unit 375 thresholds a detected physical value of the sensor 362 according to the threshold value stored in the threshold memory 316. If the detected value transcends the threshold value, the determiner unit 375 provides such a significant detected value to the mode setter unit 376.

The determiner unit 375 may threshold two or more detected values of the respective different sensors 362 (e.g., the vibration sensor, the acceleration sensor, the thermal sensor, the ambient light sensor, the human infrared (IR) sensor, and the proximity sensor), and may perform logical combined operations on the different thresholded detected values to determine significant detection of the sensors 362 for transmitting a write-ID request command or the like. For example, the determiner unit 375 may determine the significant detection by performing logical combined OR and/or AND operations on the two or more thresholded detected values.

For example, a combination of the vibration sensor and the thermal sensor may detect either movement of the reader/writer device 304 caused by a human or his or her body temperature in touch with the reader/writer device, by logical ORing the detected value of the vibration sensor and the detected value of the thermal sensor. Even if the human keeps still, his or her body temperature can be detected. This may reduce possible failure of detecting a human in touch with the reader/writer device 304.

Further, for example, it may be assumed that the human infrared sensor is too sensitive and detects too many moving things so as to provide many occurrences of false detection. In this case, the detected value of the human infrared sensor may be combined with another detected value of another sensor, in order to reduce possible false detection and enhance the accuracy of the detection.

In an initial state, the mode setter unit 376 sets or controls the reader/writer device 304 to operate in a sleep mode of operation.

In response to the significant detected value or state provided by the determiner unit 375, the mode setter unit 376 sets the reader/writer device 304 to operate in a transmit ready mode of operation. In the transmit ready mode of operation, the mode setter unit 376 controls the reader/writer device 304 to continue to stay in the transmit ready mode of operation, while it receives the significant detected value or state continuously or continually with possible intervening insignificant, short blanks or un-detection intervals. If, in the transmit ready mode of operation, a first given period of time TD1 has elapsed after discontinuation of the detected value or state received from the determiner unit 375, then the mode setter unit 376 sets the reader/writer device 304 to operate in the transmit mode of operation.

The mode setter unit 376 has a counter for counting the number, N, of times of the command transmission. The mode setter unit 376 resets the counter 378 and sets the reader/writer device 304 to operate in the sleep mode of operation, when the reader/writer device 304 receives a response signal from the RF ID tag 204 or 204′, or has completed a given maximum or limit number, n, of times of the command transmission, or when a given threshold period of time TDn has elapsed. The given period of time TDn may correspond to a time length for the given number, n, of times of the command transmission.

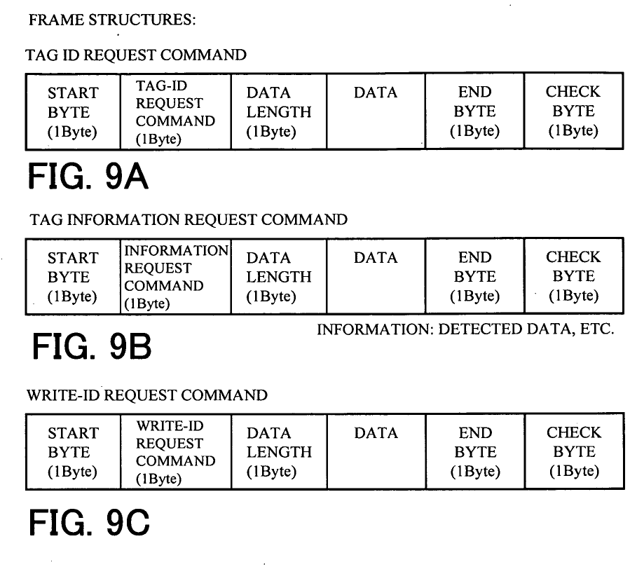

FIGS. 9A-9C illustrate exemplary frame structures which include respective different commands to be transmitted by the reader/writer devices 302, 304 and the like.

In FIG. 9A, a frame for a tag ID request includes a start byte, a tag ID request command, the length of data, data or dummy data, an end byte, and a check byte (for CRC).

In FIG. 9B, a frame for a tag information request includes a start byte, an information request command, the length of data, data or dummy data, an end byte, and a check byte (for CRC).

In FIG. 9C, a frame for a write-ID request includes a start byte, a write-ID request command, the length of data, data or dummy data, an end byte, and a check byte (for CRC).

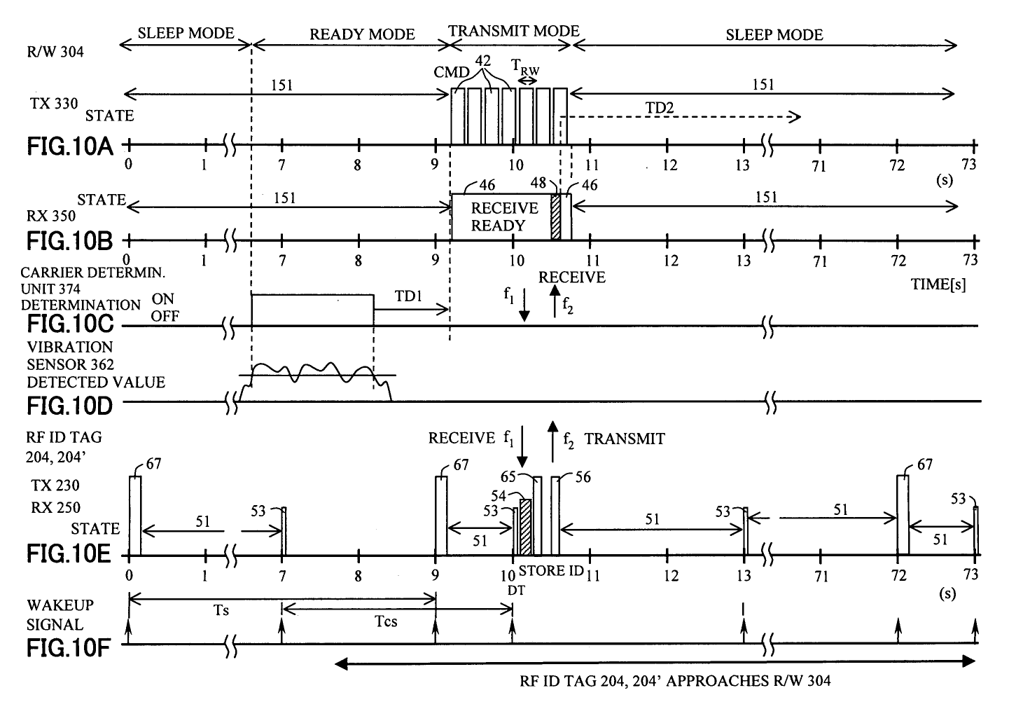

FIG. 10A illustrates a time chart of processing for transmission 42 for an RF signal carrying a write-ID request command (CMD) transmitted from the reader/writer device 304. FIG. 10B illustrates a time chart of a receive ready state 46 and of processing for reception 48 of a received RF signal in the reader/writer device 304. FIG. 10C illustrates resultant determination of a detected value of the sensor 362 by the determiner unit 375. FIG. 10D illustrates the detected value of the sensor 362. FIG. 10E illustrates a time chart of carrier sensing 53, processing 67 for detecting an ambient temperature, reading detected value data and writing the data into the memory 214, processing for reception 54 of a received RF signal, reading the stored detected value data 65 from the memory 214, and processing for transmission 56 of an RF signal carrying a response with a tag ID, in each of the active-type RF ID tags 204 and 204′.

Referring to FIG. 10A, in the initial state, the reader/writer device 304 is set by the control unit 310 to operate in the sleep mode of operation. In the sleep mode of operation, the reader/writer device 304 operate in a sleep state 151, in which only the control unit 310, the vibration sensor 362, the memory 314 (threshold memory 316) and the timer 374 are enabled or powered on, and the other elements 322-350 are disabled or powered down. Thus, the run time of the battery 390 can be extended.

Referring to FIGS. 10E and 10F, in accordance with the wakeup signal from the wakeup unit 270 in the periods of time 67 with a given duration, for example of 100 ms, occurring in a given cycle Ts (e.g., nine seconds), the control unit 210 of the active-type RF ID tag 204 (204′) enables the thermal sensor 286, the detected-data reading unit 288 and the comparator unit 279, and also enables the memory control unit 276 and the memory 214 to store the detected value data together with the current date and time into the memory 214.

On the other hand, in accordance with the wakeup signal, the control unit 210 enables the receiver unit 250 and the carrier determination unit 246 in the periods of time 53 occurring in a fixed cycle Tcs, for example of three seconds. For example, the control unit 210 may control the sensor 286 to detect the ambient temperature in a given cycle of nine seconds, and also control the receiver unit 250 and the carrier determination unit 246 to sense a carrier of a received RF signal at the frequency f₁ in a given cycle of three seconds. The lengths of the given cycles (Ts and Tcs) may be set or changed in response to a set-cycle request command from the reader/writer device 304 or 302.

Referring to FIGS. 10C and 10D, it is assumed that the distal end portion of the beer supply hose or tube 13 is moved and fitted into the supply port of the beer barrel 102. In response to the movement of the distal end portion, the sensor 362 of the reader/writer device 304 at the distal end portion may detect movement or vibration M which is larger than a threshold value Mth stored in the threshold memory 316. When the sensor 362 detects the movement M which is larger than the threshold value Mth, the control unit 310 (i.e., the determiner unit 375 and the mode setter unit 376) causes the reader/writer device 304 to enter into the transmit ready mode of operation. Even in the transmit ready mode of operation, the reader/writer device 304 continues to stay in the sleep state 151. When the distal end portion of the beer supply hose or tube 13 is fitted into the supply port of the beer barrel 102 and subsequently keeps still, the sensor 362 no longer detects further movement which is larger than the threshold value Mth.

When the given time period or threshold time TD1 has elapsed in the subsequent continuous state of no detection of movement, the control unit 310 (i.e., the mode setter unit 376) controls the reader/writer device 304 to enter into the transmit mode of operation. In the transmit mode of operation, the control unit 310 enables the data generation unit 322, transmitter unit 330, the data decoding unit 342 and the receiver unit 350.

Referring back to FIG. 10A, the enabled data generation unit 322 generates data including the write-ID request command (CMD) for an RF ID tag, and an ID representative of a beer-serving shop or restaurant and the beer server, and an ID of the reader/writer device 304. The enabled data generation unit 322 then encrypts the generated data in accordance with the given cryptosystem, and encodes the encrypted data in accordance with the given encoding scheme, to thereby produce the encoded encrypted data. The command and the IDs are pre-stored in the memory 314, and are provided by the control unit 310 to the data generation unit 322.

The transmitter unit (TX) 330 modulates the carrier with the encoded data received from the data generation unit 322 and transmits an RF signal at the frequency f₁. Under the control of the control unit 310, the transmitter unit (TX) 330 is adapted to transmit the RF signal carrying the data including the command in a given cycle T_{RW} (e.g., 100 ms or 200 ms) stored in the memory 314.

The data generation unit 322 may generate a tag information request command to be transmitted, in place of or in addition to the write-ID request command. The transmitter unit (TX) 330 transmits an RF signal carrying the data including the command.

Referring to FIG. 10E, when the reader/writer device 304 gets close to the RF ID tag 204 of the beer barrel 102 so that the RF ID tag 204 is located in the communication rage of the reader/writer device 304, the RF ID tag 204 may detect the carrier of the RF signal from the reader/writer device 304. The receiver unit 250 and the data decoding unit 242 are enabled in the time period of the subsequent processing for reception 54 with a given duration. The enabled receiver unit 250 receives and demodulates the RF signal to thereby reproduce encoded encrypted data including the command. The enabled data decoding unit 242 decodes the encoded data in accordance with the given encoding scheme, and then decrypts the decoded data in accordance with the given cryptosystem. The data decoding unit 242 then obtains the write-ID request command or the tag information request command from the decrypted data, and then provides the command to the control unit 210.

In response to the write-ID request command from the reader/writer device 304, the control unit 210, in the subsequent time period 65, stores the ID representative of the shop or restaurant and the beer server 100 and the ID of the reader/writer device 304 together with the current date and time information into the memory 214. Thus, the control unit 210 writes the IDs received from the reader/writer device 304 into the memory 214, in accordance with the write-ID request command.

In a subsequent time period or slot 56 selected at random within a given period of time, the control unit 210 controls the data generation unit 222 to encrypt response data including the tag ID and a write-complete indication in accordance with the given cryptosystem, and encode the encrypted data, and also controls the transmitter unit 230 to transmit an RF signal at the frequency f₂ carrying the encoded data back to the reader/writer device 304.

Referring to FIG. 10B, upon receipt of the RF signal carrying the response data from the RF ID tag 204 or 204′, the receiver unit 350 of the reader/writer device 304, in the processing for reception 48, demodulates the received RF signal to reproduce the encoded encrypted data. The data decoding unit 342 decodes the encoded encrypted data in accordance with the given encoding scheme and decrypts the decrypted encoded data in accordance with the given cryptosystem to thereby reproduce the response data including the response with the tag ID. The data decoding unit 342 then provides the reproduced response to the control unit 310.

In response to the receipt of the response with the tag ID, the control unit 310 (i.e., the mode setter unit 376) sets the reader/writer device 304 to operate in the sleep mode of operation. In the sleep mode of operation, the control unit 310 disables the data generation unit 322, transmitter unit 330, the data decoding unit 342 and the receiver unit 350. Thus, if the control unit 310 receives the response and the tag ID before the command is transmitted for the given number of times (n), then the control unit 310 controls the reader/writer device 304 to cease transmission of the write-ID request command and the IDs or of the tag information request command. Thus, the run time of the battery 390 can be extended.

On the other hand, once the command is transmitted for the given number of times (n) even before the control unit 310 receives the response and the tag ID, the control unit 310 (i.e., the mode setter unit 376) sets the reader/writer device 304 to operate in the sleep mode of operation. Thus, the control unit 310 controls the reader/writer device 304 to cease transmission of the write-ID request command and the ID or the tag information request command, in order to prevent it from continuing transmission of the command over a long time. Thus, the run time of the battery 390 can be extended.

After that, if the sensor 362 detects movement M which is larger than the threshold value Mth, the control unit 310 again performs the operation described above. Alternatively, once the reader/writer device 304 enters into the sleep mode of operation after the reception of the response and the tag ID, the control unit 310 may control the reader/writer device 304 to continue to stay in the sleep mode of operation until the given or threshold time period TD2 (e.g., three minutes) elapses, independently of whether the sensor 62 detects further movement M. This prevents undesirable retransmission of the write-ID request command or the tag information request command. Thus, the run time of the battery 390 can be extended.

Thus, the reader/writer device in environments subject to continual movement or vibration, can continue to stay in the sleep mode of operation until the given period of time elapses, so that undesirable power consumption of the reader/writer device due to undesirable detection of movement can be effectively suppressed and the RF ID tag can continue to stay in the sleep state for more than the given period of time. This prevents undesirable repeated transmissions of the write-ID request command or the tag information request command. Thus, the run time of the battery 390 can be extended.

The disabled state of the elements 322-350 in the sleep mode of operation and the transmit ready mode of operation of the reader/writer device 304 may reduce possible interference and collision of the command transmitted by the reader/writer device 304 with a command transmitted by another reader/writer device (e.g., the device 302) near the reader/writer device 304.

Referring back to FIG. 7B, and FIGS. 2A-2C, the receiver unit 350 of the reader/writer device 302 is constantly in the receive ready state 46. When the reader/writer device 302 associated with the mobile terminal 30 approaches the RF ID tag 204 so that the receiver unit 350 receives an RF signal from the RF ID tag 204, the receiver unit 350 demodulates the received RF signal in the time period of processing for reception 48, and then reproduces encoded encrypted data. The data decoding unit 342 decodes the encoded encrypted data in accordance with the given encoding scheme, then decrypts the decoded encrypted data, to thereby reproduce the response data. The reproduced response data includes the tag ID and the detected value data, and the ID representative of the shop or restaurant and the beer server, together with the date and time-of-day information. The data decoding unit 342 then provides the reproduced response to the control unit 310. In response to the received and reproduced response, the control unit 310 stores the tag ID and the detected value data, the ID representative of the shop or restaurant and the beer server, and the like, into the memory 314, and then stores them in the mobile terminal 30 in its storage. The stored data of the mobile terminal 30 is collected by a computer or cumulatively stored by the mobile terminal 30, so that the distribution and/or quality of the beer barrel are monitored and managed.

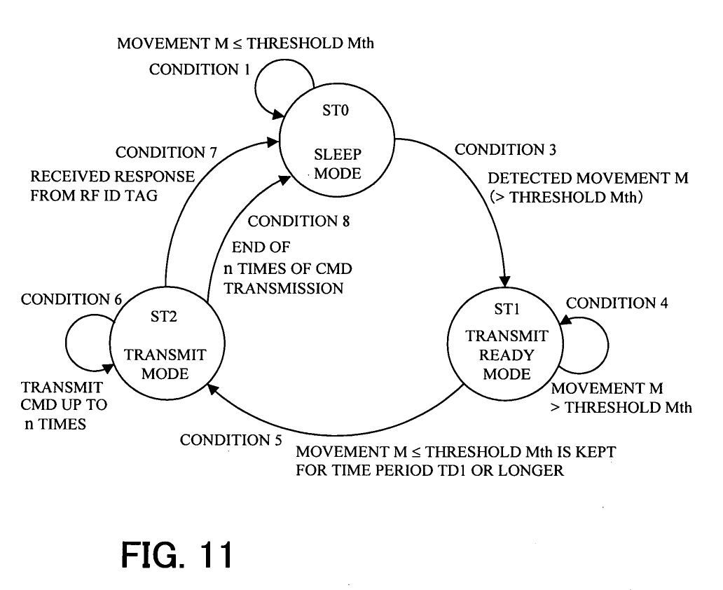

FIG. 11 illustrates an operation mode or state transition diagram of the reader/writer device 304, which is used by the mode setter unit 376 of the control unit 310.

The mode setter unit 376 in the initial state sets the reader/writer device 304 to operate in the sleep mode of operation ST0. If, in the sleep mode of operation ST0, the detected value M of movement detected by the sensor 362 does not transcend the threshold value Mth (Condition 1), the mode setter unit 376 controls the reader/writer device 304 to continue to stay in the sleep mode of operation ST0.

If, in the sleep mode of operation ST0, the detected value M of movement detected by the sensor 362 transcends the threshold value Mth (Condition 3), the mode setter unit 376 causes the reader/writer device 304 to enter into the transmit ready mode of operation ST1. If, in the transmit ready mode of operation ST1, the detected value M of movement detected by the sensor 362 continues to transcend the threshold value Mth (Condition 4), the mode setter unit 376 controls the reader/writer device 304 to continue to stay in the transmit ready mode of operation ST1. The determiner unit 375 may determine that the detected value M continues to transcend the threshold value Mth, even if the detected value M does not transcend the threshold value Mth for an insignificant, short time period not longer than a given time period TD 1 (e.g., one second) that appears between two time periods in which the respective detected values transcend the threshold value Mth.

If, in the transmit ready mode of operation ST1, the time period TD1 elapses while the detected value M of movement detected by the sensor 362 continues to be not larger than the threshold value Mth (Condition 5), then the mode setter unit 376 causes the reader/writer device 304 to enter into the transmit mode of operation ST2. In the transmit mode of operation ST2, the mode setter unit 376 controls the reader/writer device 304 to continue to stay in the transmit mode of operation, if the reader/writer device 304 receives no response from an RF ID tag, or the write-ID request command or the tag information request command has not yet been transmitted for given n times or repeatedly for a given threshold time period TDn corresponding to the n times of command transmission (Condition 6). In the transmit mode of operation ST2, the reader/writer device 304 transmits the write-ID request command for the maximum n times or repeatedly for the given threshold time period TDn.

If, in the transmit mode of operation ST2, the reader/writer device 304 receives a response from an RF ID tag before it completes transmission of the write-ID request command for the n times or repeatedly for the given time period TDn (Condition 7), then the mode setter unit 376 causes the reader/writer device 304 to enter into the sleep mode of operation ST0. If, in the transmit mode of operation ST2, the reader/writer device 304 has transmitted the write-ID request command for the n times or repeatedly for the given time period TDn (Condition 7), then the mode setter unit 376 also causes the reader/writer device 304 to enter into the sleep mode of operation ST0.

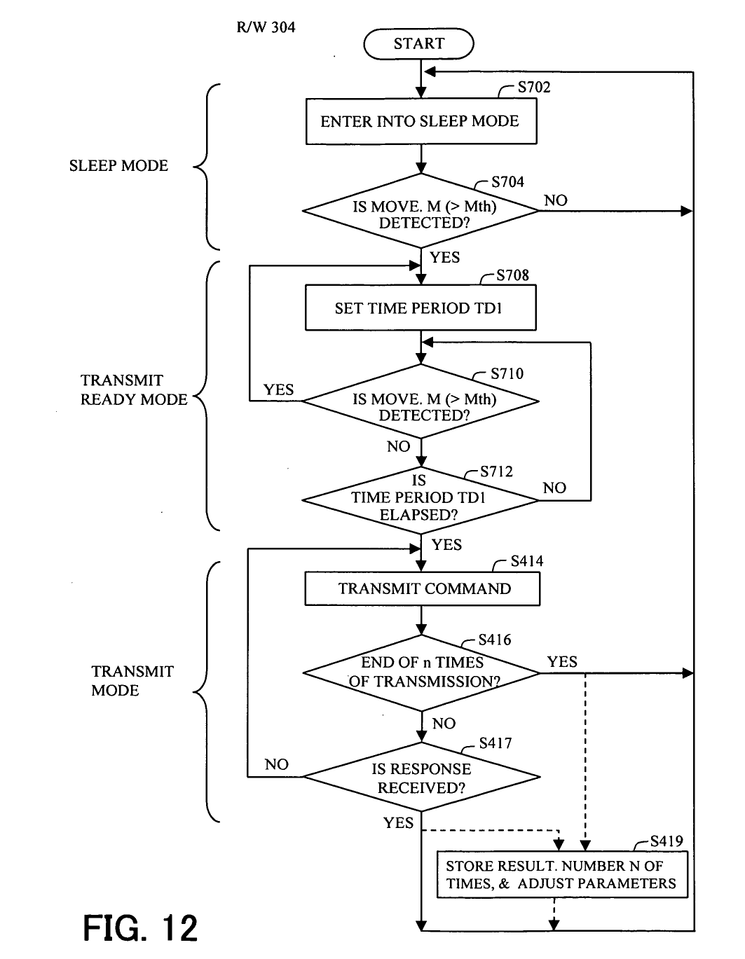

FIG. 12 illustrates a flow chart for the operation of the reader/writer device 304 that is controlled by the mode setter unit 376 of the control unit 310 in accordance with the operation mode or state transition diagram of FIG. 11.

Referring to FIG. 12, initially at Step 702, the mode setter unit 376 sets the reader/writer device 304 to operate in the sleep mode or state of operation. At Step 704, the mode setter unit 376 determines whether the detected value M of movement detected by the sensor 376 transcends the threshold value Mth. If it is determined that the detected value M does not transcend the threshold value Mth, the procedure returns to Step 702.

If it is determined at Step 704 that the detected value M transcends the threshold value Mth, the mode setter unit 376 at Step 708 causes the reader/writer device 304 to operate in the transmit ready mode of operation, and sets the time period TD1 to the timer 374. At Step 710, the mode setter unit 376 determines whether the detected value M of movement detected by the sensor 362 transcends the threshold value Mth. If it determined that the detected value M transcends the threshold value Mth, the procedure returns to Step 708.

If it determined at Step 710 that the detected value M does not transcend the threshold value Mth, the mode setter unit 376 at Step 712 determines whether the timer 374 measures and indicates the elapse of the time period TD1. If it is determined that the time period TD1 has not yet elapsed, then the procedure returns to Step 710.

If it is determined at Step 712 that the time period TD1 has elapsed, the mode setter unit 376 at Step 414 causes the reader/writer device 304 to operate in the transmit mode of operation, resets the counter 378, and causes the write-ID request command or the tag information request command to be transmitted. The counter 378 counts the number, N, of times of transmitting the command. At Step 416, the mode setter unit 376 determines whether the data generation unit 322 and the transmitter unit 330 have transmitted the command at the maximum n times or repeatedly for the given time period TDn.

If it is determined at Step 416 that the command has not yet been transmitted for the maximum n times or for the given time period TDn, then the mode setter unit 376 at Step 417 further determines whether the control unit 310 has received a response with a tag ID via the decoding unit 342 from an RF ID tag. If it is determined that it has not yet received a response or a tag ID, the procedure returns to Step 414.

If it is determined at Step 416 that the command has been transmitted for the maximum n times or for the given time period TDn, then the procedure returns to Step 702. If it is determined at Step 417 that the response and the tag ID have been received from an RF ID tag, the procedure returns to Step 702. At Step 702, the mode setter unit 376 again sets the reader/writer device 304 to operate in the sleep mode of operation.

At Step 419 following Steps 416 and 417, the mode setter unit 376 stores, into the memory 314, the resultant count number, N (≦n), of times of actual transmission of the command counted by the counter 378, before the reader/writer device 304 at Step 702 enters into the sleep mode of operation. The mode setter unit 376 may further adjust parameters, such as the first time period TD1 or the given maximum or limit number, n, of times of transmission. After that, the procedure returns to Step 702.

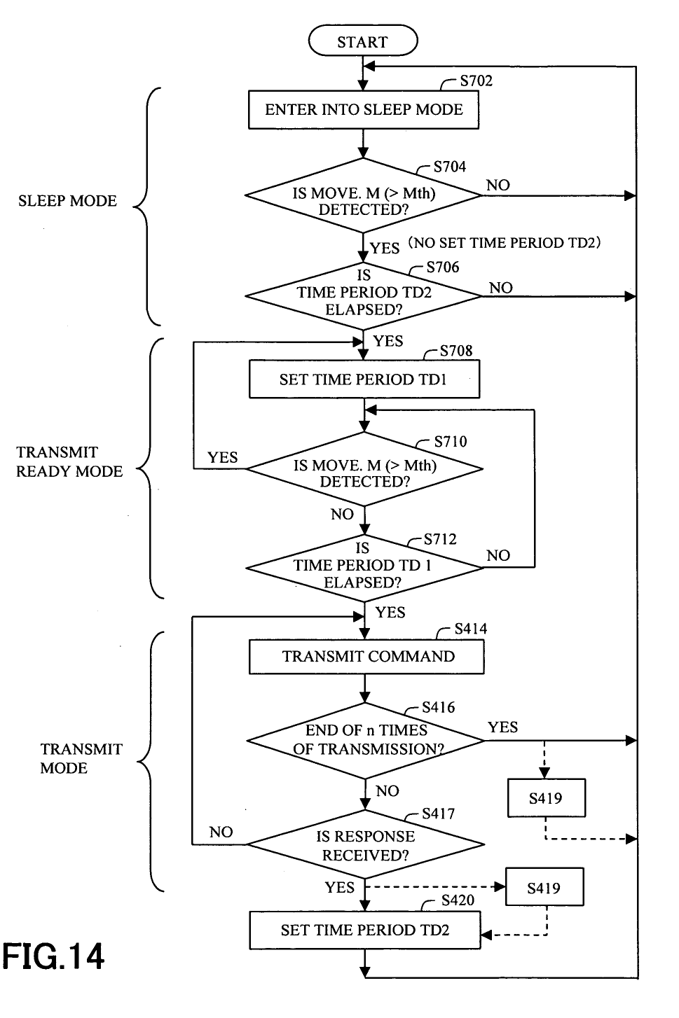

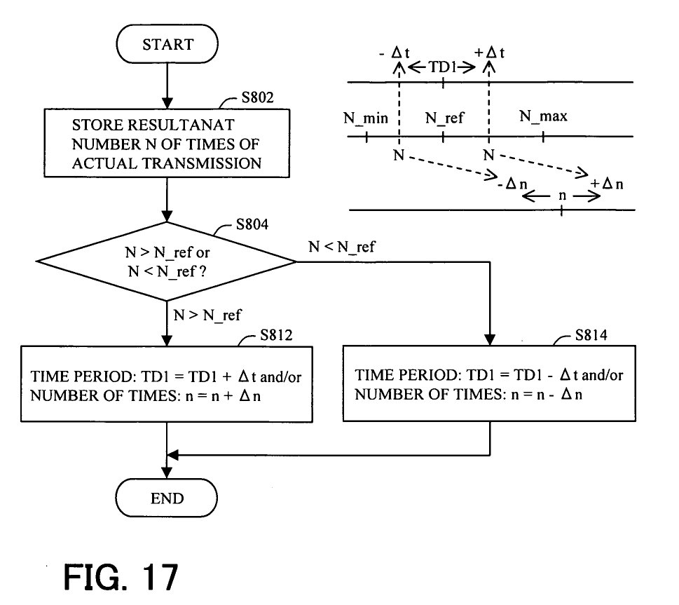

FIG. 17 illustrates a flow chart for the process of Step 419 of FIG. 12 or FIG. 14 described below, which is executed by the mode setter unit 376. The steps of FIG. 17 may be considered as function portions or circuits of the control unit 310 or the mode setter unit 376 which execute the respective steps.

Referring to FIG. 17, at Step 802, the mode setter unit 376 stores the resultant number of times, N (≦n), of actual transmission of the command counted by the counter 378. At Step 804, the mode setter unit 376 compares the resultant number, N, of times of actual transmission of the command with a reference number, N_ref, of times of transmission, and determines whether the resultant number, N, of times is above or below the reference number, N_ref, of times (N_ref<n).

If it determined at Step 802 that the resultant number, N, of times of actual command transmission is above the reference number, N_ref, of times of transmission (e.g., N_ref=thirty times) (N>N_ref) and below the maximum threshold number, N_max, of times (e.g., N_max=100 times) (N<N_max), then the mode setter unit 376 at Step 812 increases the first given time period TD1 by a given unit time length Δt (e.g., Δt=0.2 seconds) (TD1=TD1+Δt), and/or the given maximum number, n, of times of transmission by a given unit number, Δn, of times (e.g., Δn=one time) (n=n+Δn).

On the other hand, if it is determined at Step 802 that the resultant number, N, of times of actual command transmission is below the reference number, N_ref, of times of transmission (e.g., N_ref=thirty times) (N<N_ref) and above the minimum threshold number, N_min, of times (e.g., N_min=20 times) (N>N_min), then the mode setter unit 376 at Step 814 decreases the first given time period TD1 by the given unit time length Δt (e.g., Δt=0.2 seconds) (TD1=TD1−Δt), and/or the given number of times n by the given unit number, Δn, of times (e.g., Δn=one time) (n=n−Δn).

This adjusts the positions of the time period of processing for command transmission 42 and the time period of the receive ready state 46 to respective time positions at which an RF ID tag is more likely to receive the command and hence transmit a response.

Thus, the adjustment of the first given time period TD1 and the maximum number, n, of times of transmission in accordance with the comparison of the resultant number, N, of times of actual transmission with the reference number of times N_ref may allow synchronization of the transmission of the command by the reader/writer device 304 with the time period for carrier sensing by the RF ID tag. This may allow the reader/writer device 304 to read and record the detected value from the RF ID tag so that a time delay between the value detection in the RF ID tag and the data read by the reader/writer device 304 is smaller, while the battery power consumption is reduced.

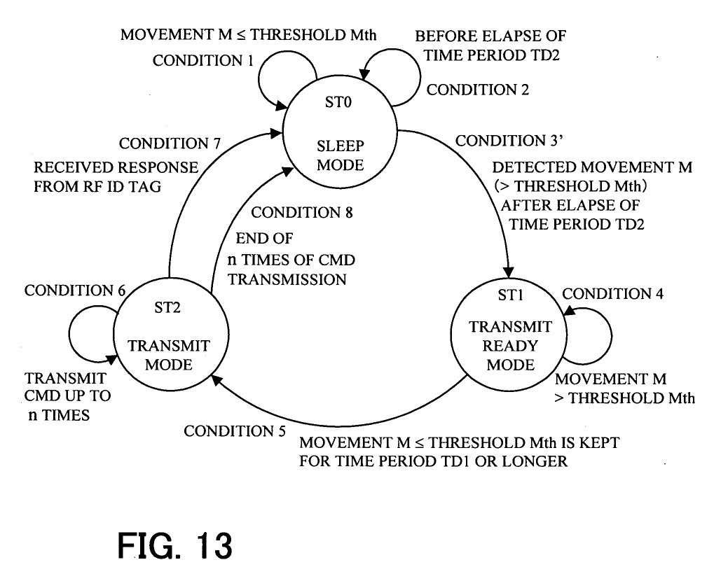

FIG. 13 illustrates another operation mode or state transition diagram of the reader/writer device 304, which is used by the mode setter unit 376 of the control unit 310. In FIG. 13, Condition 2 is added to the diagram of FIG. 11, and Condition 3 of FIG. 11 is changed to Condition 3′. The other elements of FIG. 13 are similar to those of FIG. 11.

If, in the sleep mode of operation ST0, the given time period TD2 has not yet been elapsed after the entry of the reader/writer device 304 into the current sleep mode of operation, then the mode setter unit 376 controls the reader/writer device 304 to continue to stay in the sleep mode of operation ST0, independently of the presence or absence of detection of movement M. If, in the sleep mode of operation ST0, the time period TD2 has been elapsed after the entry of the reader/writer device 304 into the current sleep mode of operation and also the detected value M of movement detected by the sensor 362 transcends the threshold value Mth (Condition 3′), then the mode setter unit 376 causes the reader/writer device 304 to enter into the transmit ready mode of operation ST1.

FIG. 14 illustrates a flow chart for the operation of the reader/writer device 304 that is controlled by the mode setter unit 376 of the control unit 310 in accordance with the operation mode or state transition diagram of FIG. 13.

In FIG. 14, Steps 702-704 are similar to those of FIG. 12.

If it is determined at Step 704 that the detected value M transcends the threshold value Mth, the mode setter unit 376 at Step 706 further determines whether or not the time period TD 2 is set to the timer 374, and whether the timer 374 measures and indicates the elapse of time period TD2 (e.g., three minutes) if the time period TD2 is set. If it is determined that the time period TD 2 is set but has not elapsed, then the procedure returns to Step 702. If it is determined at Step 706 that the time period TD2 has elapsed or is not set, then the procedure proceeds to Step 708.

Steps 708-712 and 414-417 are similar to those of FIG. 12. If it is determined at Step 417 that the control unit 310 has received neither a response nor a tag ID, the procedure returns to Step 414.

If it is determined at Step 417 that the control unit 310 has received a response and a tag ID, the mode setter unit 376 at Step 420 sets the next shortest time period TD2 of the sleep mode of operation (e.g., three minutes) to the timer 374. After that, the procedure returns to Step 702.

Referring to FIG. 14, Step 419 similar to that of FIG. 12 may be executed after the YES branch from Step 416 and before the return to Step 702. In FIG. 14, Step 419 similar to that of FIG. 12 may be executed also after the YES branch from Step 417 and before the return to Step 420.

In this embodiment, the vibration sensor is used as the sensor 362. Alternatively, the sensor 362 may be an acceleration sensor, a thermal sensor, an ambient light sensor, or the like, as described above.

The steps of FIGS. 12 and 14 may be considered as function portions or circuits of the control unit 310 (the determiner unit 375 and the mode setter unit 376), which executes the respective steps.

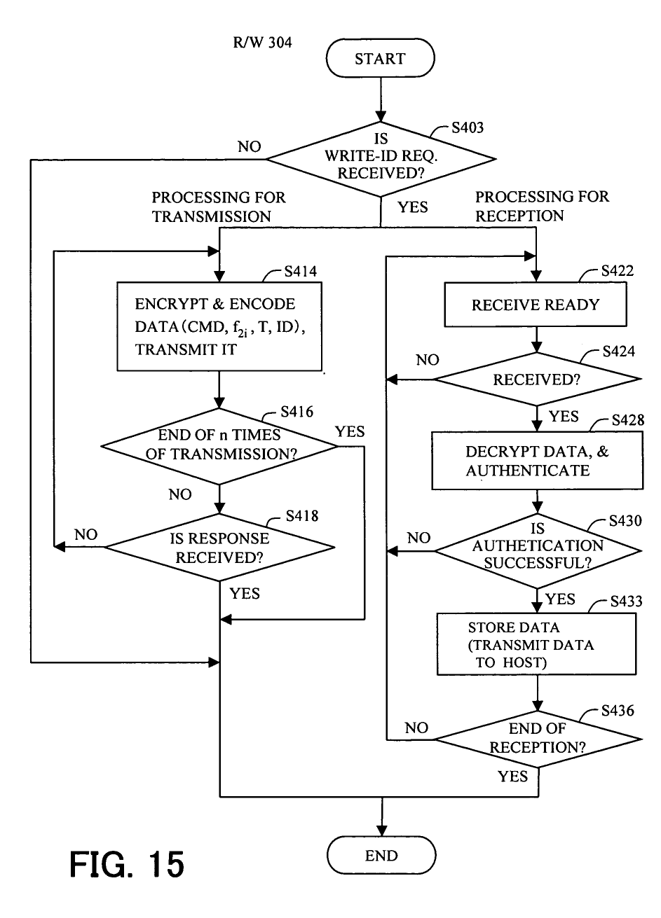

FIG. 15 illustrates a flow chart for the processing in the transmit mode of operation, which is performed by the reader/writer device 304. The processing for transmission of FIG. 15 corresponds to Steps 414-417 of FIG. 14. The steps of FIG. 15 may be considered as function portions or circuits of the control unit 310 (the determiner unit 375 and the mode setter unit 376), which executes the respective steps.

Referring to FIG. 15, at Step 403, the control unit 310 of the reader/writer device 304 determines whether a write-ID request and an ID to be written are stored in the memory 314. If it determined that there is no write-ID request, the procedure exits the routine of FIG. 15. If it determined that there is such a write-ID request, the procedure proceeds to Step 414 for processing for transmission and to Step 422 for processing for reception.

Step 414 is similar to that of FIG. 3. At Step 414, an RF signal carrying a command including a write-ID request is transmitted. Alternatively, it may be determined at Step 403 whether there is a tag information request to be transmitted. If it is determined that there is such a request, the procedure may proceed to Steps 414 and 422.

At Step 416, the control unit 310 determines whether the command including the write-ID request command has been transmitted for the given number, n, of times or repeatedly for the given time period TDn. If it is determined that it has been transmitted for the given number, n, of times or repeatedly for the given time period TDn, the procedure exits the routine of FIG. 15.

If it is determined at Step 416 that it has not yet been transmitted for the given number, n, of times or for the given time period TDn, then the control unit 310 at Step 417 further determines whether it has received a response with a tag ID. If it is determined that it has received neither a tag ID nor a response, the procedure. returns to Step 414. If it is determined that it has received a response and a tag ID, the procedure proceeds to Step 436.

Steps 422-436 for processing for reception of FIG. 15 are similar to those of FIG. 3. At Step 432 following Step 430, the control unit 310 of the reader/writer device 304 stores the received data in the memory 314. In addition, when the reader/writer device 304 is connected to the host computer, the control unit 310 may provide the received data to the host computer. After that, the procedure proceeds to Step 436.

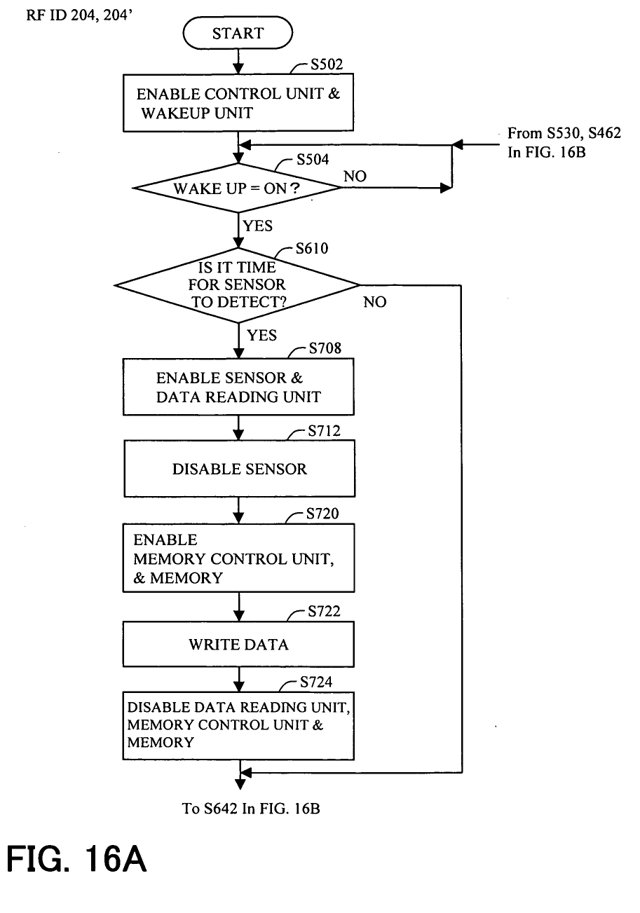

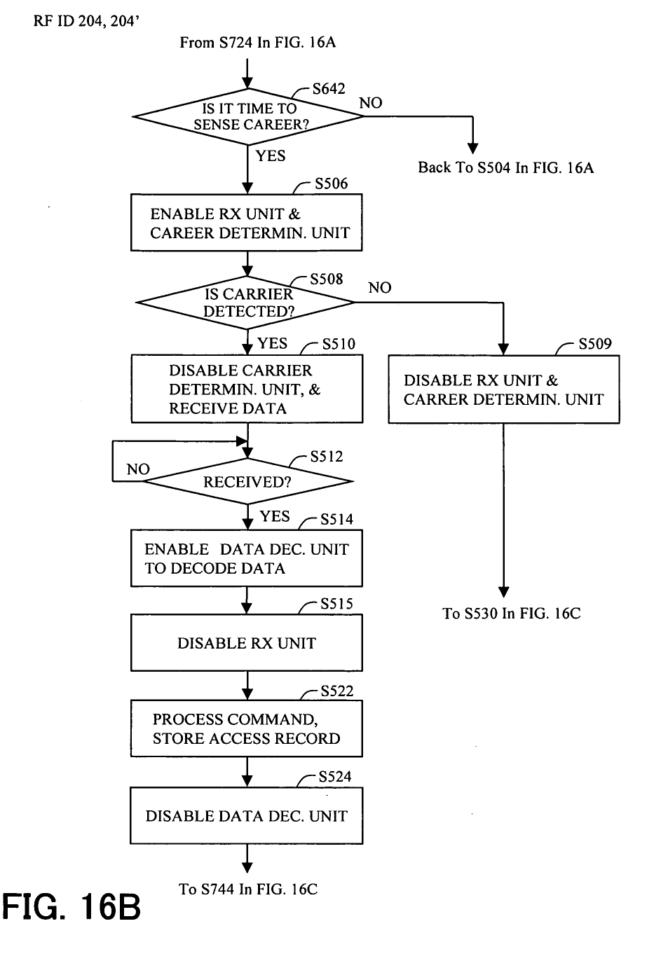

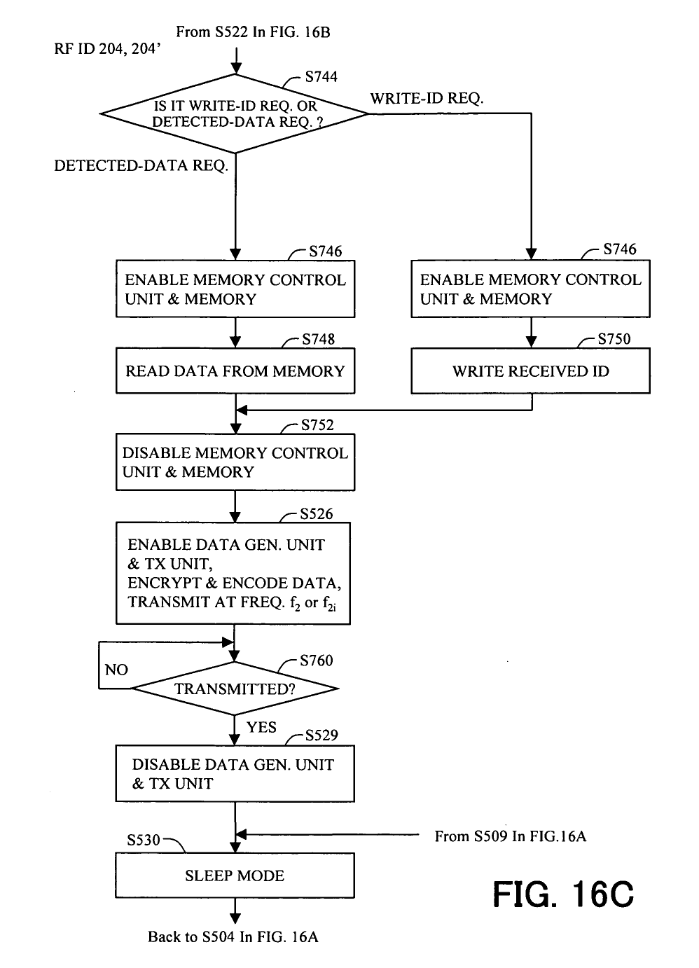

FIGS. 16A-16C illustrate a flow chart for processing which is executed by the active-type RF ID tag 204 or 204′. In FIGS. 16A-16C, the steps of the processing for authentication of FIGS. 4A and 4B are not indicated for simplicity.

Referring to FIG. 16A, Steps 502-504 are similar to those of FIG. 4A.

At Step 610, the control unit 210 determines in accordance with the wakeup signal whether it is time for the thermal sensor 286 to detect the temperature. If it determines that it is not, the procedure proceeds to Step 642 of FIG. 13B. If it is determined that it is time to detect the temperature, the control unit 210 at Step 708 enables the thermal sensor 286 and the detected-data reading unit 288 to detect the temperature and read the detected value.

At Step 712, the control unit 210 disables the sensor 286.

At Step 720, the control unit 210 enables the memory control unit 276 and the memory 214. At Step 722, the control unit 210 temporarily enables the comparator unit 287, and the memory control unit 276 stores the current detected temperature value Dc from the comparator unit 287 as the stored detected temperature value Ds in the memory 214. At Step 724, the control unit 210 disables the detected-data reading unit 288, the memory control unit 276 and the memory 214.

Referring to FIG. 16B, at Step 642, the control unit 210 determines in accordance with the wakeup signal whether it is time to sense a carrier. If it is determined that it is not, the procedure returns to Step 504 of FIG. 16A.

If it is determined at Step 642 that it is time to sense a carrier, the procedure proceeds to Step 506. Steps 506-515 of FIG. 16B are similar to those of FIG. 4A.

At Step 522 following Step 515, the control unit 210 receives decoded decrypted data including the write-ID or tag information request command from the data decoding unit 242, processes the decrypted received command included in the decrypted data, and stores a record of access performed by the reader/writer device 304 in the memory 214. At Step 524, the control unit 210 disables the data decoding unit 242.

Referring to FIG. 16C, at Step 744, the control unit 210 determines whether the received command is a write-ID request command or a detected data request command as a tag information request command. If it is determined that it is a write-ID request command, the procedure proceeds to Step 746.

At Step 746 (at the right in FIG. 16C), the control unit 210 enables the memory control unit 276 and the memory 214. At Step 750, the control unit 210 causes the memory control unit 276 to store the received ID together with the current date and time information in the memory 214. At Step 752, the control unit 210 disables the memory control unit 276 and the memory 214.

If it is determined at Step 744 that the command is a detected data request command, the control unit 210 at Step 746 (at the left in FIG. 16C) enables the memory control unit 276 and the memory 214. At Step 748, the control unit 210 causes the memory control unit 276 to read the stored data in the memory 214, i.e., the detected data and the received ID together with the associated date and time. At Step 752, the control unit 210 disables the memory control unit 276 and the memory 214.

Step 526 is similar to that of FIG. 4B. At Step 526, the control unit 210 transmits, to the reader/writer device 302, an RF signal carrying data including the encoded encrypted stored data of the detected temperature values, the written received IDs, and the associated date and time information T.

At Step 760, the control unit 210 determines whether the transmission of the requested data is completed. Step 760 is repeated until it is completed. If it is determined that the transmission of requested data is completed, the procedure proceeds to Step 529. Step 529 is similar to that of FIG. 4B.

At Step 530, the control unit 210 causes the RF ID tag 204 or 204′ to enter into the sleep mode of operation. In the sleep mode of operation, only the control unit 210 and the wakeup unit 270 are enabled or powered on, and the other elements 214, 216, 222-250, 276 and 286-288 are disabled or powered down. After that, the procedure returns to Step 504.

According to the embodiment described above, transportation route and experienced temperatures along the route of a merchandise article, which requires low-temperature control and has the RF ID tag with the thermal sensor, can be traced and collected by the reader/writer device associated with a refrigerator or freezer, through the communication between the RF ID tag and the reader/writer device.

According to the embodiment described above, the transmission of a command by the reader/writer device may be discontinued after the given number of times of the command transmission is completed, whereby the power consumption can be reduced. This is effective, in particular, when an RF ID tag cannot transmit back a response, for example, by an accident such as a failure of its antenna.

According to the embodiment described above, transmission of a command by the reader/writer device may be discontinued after the given time period of the command transmission, whereby the power consumption can be reduced. This is effective, in particular, in case of an abnormal long operation for transmission in the reader/writer device, such as transmission of excessive amount of data due to a malfunction of the program of the reader/writer device.

According to the embodiment described above, the write-ID requests may include unique identifications of respective reader/writer devices for respective systems. The bit length of the identifications for the respective reader/writer devices in the respective systems may be changed or adjusted as desired depending on the number of the reader/writer devices to be used in the respective systems, so that the bit length of the identifications is adapted for transmission.

Although the embodiments have been described in connection with application to the RF ID tags, it should be understood by those skilled in the art that the invention is not limited to this application and is also applicable to contactless IC cards.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a physical quantity detector unit which transforms a physical quantity into an electric signal and provides a detected value represented by the electric signal;
a physical quantity determiner unit which determines whether the detected value provided by the physical value quantity detector unit is larger than a given threshold value;
a timer unit which measures a time period during which it continues to be determined that the detected value is not larger than the given threshold value, in response to the determination that the detected value is not larger than the given threshold value after it is determined by the physical quantity determiner unit that the detected value is larger than the given threshold;
a transmitter unit which transmits a request signal for requesting transmission of data, in response to the time period measured by the timer unit transcending a first given time threshold; and
a receiver unit which receives transmitted data which is transmitted in response to the request signal.

2. The information processing apparatus according to claim 1, further comprising a control unit which starts supplying power to the transmitter unit in response to the time period measured by the timer unit transcending the first given time threshold, and stops supplying power to the transmitter unit in response to the reception of data by the receiver unit.

3. The information processing apparatus according to claim 1, further comprising a counter unit which counts a number of times of transmission of the request signal by the transmitter unit, wherein, if the number of times of transmission counted by the counter unit transcends a given threshold number of times of transmission, then the control unit resets the number of times of transmission and stops supplying power to the transmitter unit, and wherein the transmitter unit repeats the transmission of the request signal until the data is received by the receiver unit.

4. The information processing apparatus according to claim 1, wherein the timer unit measures the time period during which the power continues to be supplied to the transmitter unit, after the control unit starts supplying power to the transmitter unit, and wherein,
in response to the time period measured by the timer unit transcending a second given time threshold, the control unit stops supplying power to the transmitter unit.

5. The information processing apparatus according to claim 2, wherein, after the stop of supplying power to the transmitter unit, the timer unit measures a time period during which no power is supplied to the transmitter unit, and wherein
the control unit disables supplying power to at least one of the physical quantity detector unit and the physical quantity determiner unit, until the time period measured by the timer unit transcends a second given time threshold.

6. The information processing apparatus according to claim 3, wherein, after the stop of supplying power to the transmitter unit, the timer unit measures a time period during which no power is supplied to the transmitter unit, and wherein
the control unit disables supplying power to at least one of the physical quantity detector unit and the physical quantity determiner unit, until the time period measured by the timer unit transcends a second given time threshold.

7. The information processing apparatus according to claim 4, wherein, after the stop of supplying power to the transmitter unit, the timer unit measures a time period during which no power is supplied to the transmitter unit, and wherein
the control unit disables supplying power to at least one of the physical quantity detector unit and the physical quantity determiner unit, until the time period measured by the timer unit transcends a second given time threshold.

8. The information processing apparatus according to claim 3, wherein the control unit determines whether the resultant number of times of transmission counted by the counter unit is above or below a given reference number of times of transmission, and wherein, when it is determined that the resultant number of times of transmission counted by the counter unit is above the given reference number of times of transmission, the control unit increases at least one of the first given time threshold and the transmission threshold number of times of transmission, and wherein, when it is determined that the resultant number of times of transmission counted by the counter unit is below the given reference number of times of transmission, the control unit decreases at least one of the first given time threshold and the transmission threshold number of times of transmission.

9. The information processing apparatus according to claim 1, wherein the request signal carries a write-identification request made to a device which receives the request signal.

10. A computer-readable storage medium storing a program, the program which allows an information processing apparatus to realize:
a physical quantity input unit which receives an input of an electric signal into which a detected value representative of a physical quantity is transformed;
a physical quantity determiner unit which determines whether the detected value is larger than a given threshold value;
a timer unit which measures a time period during which it continues to be determined that the detected value is not larger than the given threshold value, in response to the determination that the detected value is not larger than the given threshold value after it is determined by the physical quantity determiner unit that the detected value is larger than the given threshold; and
a control unit which controls a transmitter unit to transmit a request signal for requesting transmission of data, in response to the time period measured by the timer unit transcending a first given time threshold, and which further controls a receiver unit to receiving transmitted data which is transmitted in response to the request signal.

11. A transceiver circuit comprising:
a physical quantity input unit which receives an input of an electric signal into which a detected value representative of a physical quantity is transformed;
a physical quantity determiner unit which determines whether the detected value is larger than a given threshold value;
a timer unit which measures a time period during which it continues to be determined that the detected value is not larger than the given threshold value, in response to the determination that the detected value is not larger than the given threshold value after it is determined by the physical quantity determiner unit that the detected value is larger than the given threshold;
a transmitter unit which transmits a request signal for requesting transmission of data, in response to the time period measured by the timer unit transcending a first given time threshold; and
a receiver unit which receives transmitted data which is transmitted in response to the request signal.
